(19) United States
(12) Patent Application Publication
(10) Pub. No.: US 2026/0316972 A1
(43) Pub. Date: Oct. 15, 2026

(54) UNMANNED AERIAL VEHICLE SYSTEMS FOR REMOTE TESTING AND INSPECTION OF OBJECTS

(71) Applicant: Persimia LLC, Marietta, GA (US)

(72) Inventors: Arjun Krishnan, Smyrna, GA (US); Ashwin Krishnan, Smyrna, GA (US); Samuel Kemp, Atlanta, GA (US); Jonathan Rogers, Roswell, GA (US)

(21) Appl. No.: 19/535,800

(22) Filed: Feb. 10, 2026

Related U.S. Application Data
(63) Continuation of application No. PCT/US2026/014736, filed on Feb. 10, 2026.
(60) Provisional application No. 63/787,054, filed on Apr. 11, 2025.

(51) Int. Cl. B64U 50/13; B64U 10/13; B64U 10/14; B64U 80/25

(52) U.S. Cl. CPC B64U 50/13; B64U 10/13; B64U 10/14; B64U 80/25; B64U 2201/10; B64U 2201/104

(57) ABSTRACT

Systems and methods relating to an unmanned aerial vehicle (UAV) are disclosed. The UAV can comprise a body and one or more rotor assemblies attached to the body and configured to generate lift. The UAV can include an anchor system attached to the body and configured to detachably attach to a surface, and the UAV can include a gantry system attached to the body and located at the bottom the body. One or more sensors can be attached to the gantry.

### CROSS-REFERENCE TO RELATED APPLICATIONS

This application is a continuation of, and claims the benefit of, and priority to, International Application No. PCT/US 2026/014736, filed on Apr. 10, 2026, and entitled “Unmanned Aerial Vehicle Systems for Remote Testing and Inspection of Objects,” which claims the benefit of, and priority to, U.S. Provisional Patent Application No. 63/787,054, filed on Apr. 11, 2025, and entitled “Unmanned Aerial Vehicle Systems for Remote Testing and Inspection of Objects,” the disclosures of which are incorporated by reference in the respective entireties as if set forth herein.

### STATEMENT REGARDING FEDERALLY SPONSORED RESEARCH OR DEVELOPMENT

This invention was made with government support under Grant Number DE-SC0022680 awarded by the Department of Energy. The government has certain rights in the invention.

### TECHNICAL FIELD

This application generally relates to systems and methods for inspecting physical structures and more specifically to employing unmanned aerial vehicle systems to inspect, monitor, and/or repair wind turbines and/or other physical structures.

### BACKGROUND

Nondestructive testing (NDT) can be a critical process in various industries (e.g., aerospace, infrastructure, and energy), particularly those in which structural integrity and safety are paramount. Conventional NDT methods often require manual inspection by trained personnel, necessitating direct access to inspection targets such as bridges, pipelines, wind turbines, and aircraft. These inspections can be time-consuming, costly, and hazardous, particularly when dealing with high-altitude structures, confined spaces, remote locations, or the like.

Some systems have attempted to utilize unmanned aerial vehicle (UAV) technology to perform inspection tasks. For example, some UAVs have been outfitted with cameras to perform visual inspections; however, existing systems are often limited in their ability to accurately and reliably perform advanced NDT techniques due to several factors, such as lack of direct contact with inspection targets and/or an inability to sufficiently stabilize existing UAVs to perform precise measurements, as non-limiting examples. Moreover, existing systems suffer similar shortcomings with respect to remotely performing repairs using UAVs. That is to say, existing UAV-based systems are generally unable to accurately and reliably perform repairs because they are unable to maintain contact with the corresponding structure or object and/or maintain sufficient stabilization for repair tools or devices to operate.

Accordingly, there remains a long-felt and unsolved need for a UAV system capable of effectively performing inspection operations and/or repair operations on target objects while maintaining stability, accuracy, and/or adaptability to different testing environments. An improved UAV-based solution would enhance the reliability and accessibility of inspections, reduce operational costs, and decrease or minimize risks associated with manual inspections and repairs.

### BRIEF SUMMARY OF THE DISCLOSURE

Briefly described, aspects of the present disclosure generally relate to systems and methods for inspecting and/or repairing physical structures. The disclosed technology includes an unmanned aerial vehicle (“UAV” or “drone”) for performing Nondestructive Testing (“NDT”) of an inspection target, whether done remotely or while in contact with the inspection target. Remote NDT can occur while the UAV is airborne and not in contact with the inspection target. Contact NDT can occur when the vehicle is in contact and/or attached to the inspection target. The NDT scanning process can use visual, thermal, acoustic, and/or other remote or contact sensing equipment. Stated differently, the UAV can include one or more visual sensors (e.g., one or more visible spectrum imaging devices), one or more thermal sensors (e.g., one or more infrared spectrum imaging devices), one or more acoustic sensors, one or more microwave sensors, or the like, or any combination thereof. The flight path of the UAV can be manually set (e.g., via a user interface in communication with the UAV), semi-autonomous, or fully autonomous (e.g., fully operated by a controller of the disclosed technology). The UAV can be configured to “dock” to the target to perform NDT inspection methods that require contact. NDT techniques—such as ultrasonic or microwave scans—can provide more information about the internal state of the target than could otherwise be assessed remotely.

The UAV can be configured to perform one or more inspection operations and/or one or more repair operations on one or more targets (e.g., one or more objects, structures, or the like upon which the inspection operation(s) and/or repair operation(s) are being performed). For example, the UAV system can include a gantry system. The gantry system can function as a movable system capable of moving one or more NDT sensors and/or repair tools within a two-dimensional space (or three-dimensional space). For example, the gantry system can be attached to the underside of the UAV. Continuing this example, once the UAV system is deployed and attached to the target object (e.g., the blade of a wind turbine), the gantry system can move within its predefined two-dimensional space (or three-dimensional space) and perform inspections and/or repairs using the NDT sensors and/or the NDT tools.

The UAV can include a controller (e.g., computing device) comprising one or more processors and memory having instructions stored thereon that, when executed by the one or more processors, cause one or more components of the UAV to perform various actions or functionalities, such as those shown and described herein. The UAV can include a transceiver (e.g., a wireless transceiver), which can be configured to communicate (e.g., wirelessly communicate) with a remote controller, whether human-operated or automatically operated by a ground-based computing system. Alternatively or in addition, the controller can be configured to autonomously perform one or more actions or functionalities, thereby providing semi-autonomous functionality (e.g., the UAV can perform certain operations, but not necessarily all possible operations, without human input and/or without any outside input) or fully autonomous functionality (e.g., the UAV can perform all operations without human input and/or without any outside input)

The UAV can include an onboard battery system, can be configured to fly (e.g., via one or more rotor assemblies), and can be configured to dock to the structure, assembly, or object for which inspection is desired (“inspection target”). This functionality can be provided by one or more components on the UAV, such as an attachment assembly, a navigation sensor, robust flight software, or any combination thereof, as non-limiting examples. The attachment assembly can include one or more end effectors (e.g., each with one or more magnetic components), one or more vacuum suction devices, or any other device configured to detachably attach or releasably anchor the UAV (or some portion thereof) to the inspection target.

The attachment assembly can include an articulated (or articulable) device with one or more degrees of freedom. Alternatively or in addition, the attachment assembly can include a shock absorbing mechanism.

The navigation sensor can include one or more sensors to determine a current position or location of the UAV, detect environmental objects around or near the UAV, or detect proximity of the UAV to the inspection target, as non-limiting examples. The one or more sensors can include, as non-limiting examples, one or more visible spectrum cameras, one or more LiDAR scanners, one or more infrared sensors, one or more ultrasonic sensors, one or more geolocation sensors, one or more magnetometers, one or more inertial measurement units (IMUs) (e.g., accelerometer(s) and/or gyroscope(s)), or other sensors, or any combination thereof.

The flight software can be configured to operate in one or more different modes, such as a manual flight mode, a semi-autonomous flight mode (e.g., providing pilot assist functionality), or a fully autonomous mode (e.g., to enable safe and repeatable dock and undock maneuvers).

The UAV can perform remote inspections to monitor inspection targets and/or perform remote repair operations thereoto. The UAV can be manually flown to, near, or around the target, or the UAV can be flown in the assisted flight mode or the fully-autonomous mode. During flight, the UAV is configured to identify critical areas and mark those critical areas for further inspection (e.g., automatically identify and/or recognize the critical areas and store one or more references indicative of those critical areas for subsequent inspection). Alternatively or in addition, the UAV, a controller device in communication with the UAV, or some other component or device in communication with the UAV can be configured to receive user input indicative of critical areas or other areas to be inspected. For example, the user or pilot can select a location or area shown on a display of the controller device, as a non-limiting example. Once a critical area has been identified, a docking area on the inspection target can be identified. The UAV can be configured to automatically identify the docking area based on, as non-limiting examples, proximity to the critical inspection areas, topography and/or structural or other physical characteristics of the inspection target, or the like. Alternatively or in addition, a remote user or pilot can manually identify and/or confirm the docking area (e.g., using video or images captured by a camera of the UAV). Regardless, once the docking area is determined, the UAV can be configured to perform a fully autonomous docking maneuver. Once the UAV is docked, an onboard robotic actuator can move an NDT sensor to perform the corresponding movements necessary for the particular type of NDT sensor to accurately collect inspection data, which can depend on the NDT technology implemented by the particular NDT sensor (e.g., contact sensor or non-contact sensor). The NDT sensor on the UAV can be controlled manually by the remote user or by a controller of the UAV (whether located locally on the UAV or at a remote computing system). The controller can be configured to instruct the NDT sensor, robotic actuator, and/or any other components to conduct one or more pre-determined scan patterns. Alternatively or in addition, the controller can be configured to generate one or more scan patterns based at least in part on the particular physical characteristics of the inspection target, environmental conditions (e.g., ambient light, precipitation, humidity, wind), or the like, or any combination thereof, and the controller can be configured to instruct the NDT sensor, robotic actuator, and/or any other components to conduct one or more generated scan patterns.

The disclosed technology includes an unmanned aerial vehicle (UAV) comprising: a body; one or more rotor assemblies attached to the body, the one or more rotor assemblies being configured to generate lift; an anchor system attached to the body, the anchor system being configured to detachably attach to a surface of an object; and a gantry system attached to the body.

The gantry system can be located at a bottom of the body.

The gantry system can comprise: one or more tracks extending along a first axis; a gantry arm extending along a second axis that is approximately perpendicular to the first axis, the gantry arm being configured to traverse the one or more tracks in either direction along the first axis; and a carriage configured to traverse the gantry arm in either direction along the second axis.

The UAV can comprise one or more sensors attached to the carriage. Alternatively or in addition, the UAV can comprise one or more repair tools attached to the carriage.

The anchor system can comprise one or more anchor structures configured to rotate relative to the body to thereby transition the one or more anchor structures between (i) a first position in which one or more anchor points of the one or more anchor structures face in a generally front-facing direction that extends away from a front of the body and (ii) a second position in which the one or more anchor points of the one or more anchor structures face in a generally bottom-facing direction that extends away from a bottom of the body.

Each of the one or more anchor points can correspond to one or more suction devices.

The anchor system comprises the one or more suction devices; and the UAV further comprises a pump system in fluid communication with the one or more suction devices to thereby create a vacuum within the one or more suction devices to enable the one or more suction devices to form a seal with the surface.

The UAV can comprise one or more micro-electromechanical systems (MEMS) pressure sensors each configured to monitor a pressure within a corresponding one of the one or more suction devices.

The UAV can comprise a controller configured to: output instructions for the pump system to activate; determine that the one or more suction devices is maintaining a vacuum with the surface based at least in part on pressure data received from the one or more MEMS pressure sensors; and output instructions for the body to rotate relative to the one or more anchor structures to thereby cause the bottom of the body to generally face the surface of the object.

The one or more anchor structures can comprise one or more legs of the UAV.

The one or more anchor structures can comprise one or more anchor arms of the anchor system, and/or the anchor system can be attached to a front of the UAV.

The anchor system can comprise: a base having a proximate end attached to the front of the UAV; an anchor hub, wherein the one or more anchor structures is attached to the anchor hub; and a hinging mechanism disposed between the base and the anchor hub, the hinging mechanism being configured to transition between an unhinged position and a hinged position, wherein the unhinged position corresponds to the first position of the one or more anchor structures and the hinged position corresponds to the second position of the one or more anchor structures.

The UAV can comprise a rotation device disposed between the hinging mechanism and the one or more anchor structures, wherein the rotation device is configured to rotate the body relative to the one or more anchor structures when the one or more anchor structures are attached to the surface.

The anchor system can be a primary anchor system. The UAV can comprise a secondary anchor system configured to (i) contact the surface after the primary anchor system detachably attaches to the surface and (ii) detachably attach to the surface.

The UAV can comprise one or more legs, and/or the secondary anchor system can comprise one or more secondary suction cups attached to one or more legs.

The secondary anchor system can be attached to the gantry system.

The disclosed technology includes an unmanned aerial vehicle (UAV) comprising: a body; one or more rotor assemblies attached to the body, the one or more rotor assemblies being configured to generate lift; an anchor system attached to a front of the body, the anchor system being configured to detachably attach to a surface; and a polar gantry system comprising: an arm; a rotating collar configured to rotate the arm relative to the body; and a carriage configured to traverse at least a portion of the arm.

The disclosed technology includes an unmanned aerial vehicle (UAV) comprising: a body; one or more rotor assemblies attached to the body, the one or more rotor assemblies being configured to generate lift; and an anchor system attached to the body, the anchor system comprising: one or more anchor structures each comprising one or more suction devices; and a hinging mechanism configured to transition the one or more anchor structures between (i) an unhinged position in which one or more anchor points of the one or more anchor structures face a generally front-facing direction that extends away from a front of the body and (ii) a second position in which the one or more anchor points of the one or more anchor structures face in a generally bottom-facing direction that extends away from a bottom of the body, wherein the anchor system is configured to detachably attach to a surface of an object at the one or more anchor points.

The UAV can comprise a gantry system attached to the body and located at the bottom the body.

These and other aspects, features, and benefits of the claimed innovation(s) will become apparent from the following detailed written description of the preferred examples and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more examples and/or aspects of the disclosure and, together with the written description, serve to explain the principles of the disclosure. Wherever possible, the same reference numbers are used throughout the drawings to refer to the same or like elements of the disclosed systems and processes, and wherein:

FIG. 1A illustrates an isometric view of an example unmanned aerial vehicle (UAV) in a first configuration, in accordance with the disclosed technology;

FIG. 1B illustrates an isometric view of an example UAV in a second configuration, in accordance with the disclosed technology;

FIG. 1C illustrates a bottom view of an example UAV in the first configuration, in accordance with the disclosed technology;

FIG. 2 illustrates multiple stages of an example UAV inspecting a wind turbine blade, in accordance with the disclosed technology;

FIG. 3 illustrates an isometric view of an example UAV, in accordance with the disclosed technology;

FIG. 4 illustrates an isometric view of an example UAV in the first configuration, in accordance with the disclosed technology;

FIG. 5 illustrates a top isometric view of an example UAV in the second configuration, in accordance with the disclosed technology;

FIG. 6 illustrates a bottom isometric view of an example UAV in the second configuration, in accordance with the disclosed technology;

FIG. 7 illustrates an isometric view of an example UAV, in accordance with the disclosed technology;

FIG. 8 illustrates an isometric view of an example UAV in the first configuration, in accordance with the disclosed technology;

FIG. 9 illustrates an isometric view of an example UAV in a second configuration, in accordance with the disclosed technology;

FIG. 10 illustrates an example tether system, in accordance with the disclosed technology;

FIGS. 11A and 11B illustrate top and side views, respectively, of an example UAV configuration, in accordance with the disclosed technology;

FIGS. 12A and 12B illustrate top and side views, respectively, of an example UAV configuration, in accordance with the disclosed technology;

FIG. 12C illustrates an isometric view of an example UAV, in accordance with the disclosed technology;

FIG. 13 illustrates an example principle component analysis of LiDAR data obtained by an example UAV, in accordance with the disclosed technology;

FIG. 14 illustrates a state diagram for an example dock sequence, in accordance with the disclosed technology;

FIG. 15 illustrates an example control device providing a pilot view for control of the UAV, in accordance with the disclosed technology; and

FIG. 16 illustrates an example computing infrastructure of an example UAV, in accordance with the disclosed technology.

### DETAILED DESCRIPTION

The disclosed technology relates generally to apparatuses, systems, and methods for inspecting structures and, more particularly, to using unmanned aerial vehicles to inspect structures (e.g., wind turbines). Some examples of the disclosed technology will be described more fully with reference to the accompanying drawings. This disclosed technology can, however, be embodied in many different forms and should not be construed as limited to the examples set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

In the following description, numerous specific details are set forth. But it is to be understood that examples of the disclosed technology can be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to and are not intended to imply that the objects so described should be in a given sequence, either temporally, spatially, in ranking, or in any other manner.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Example Embodiments

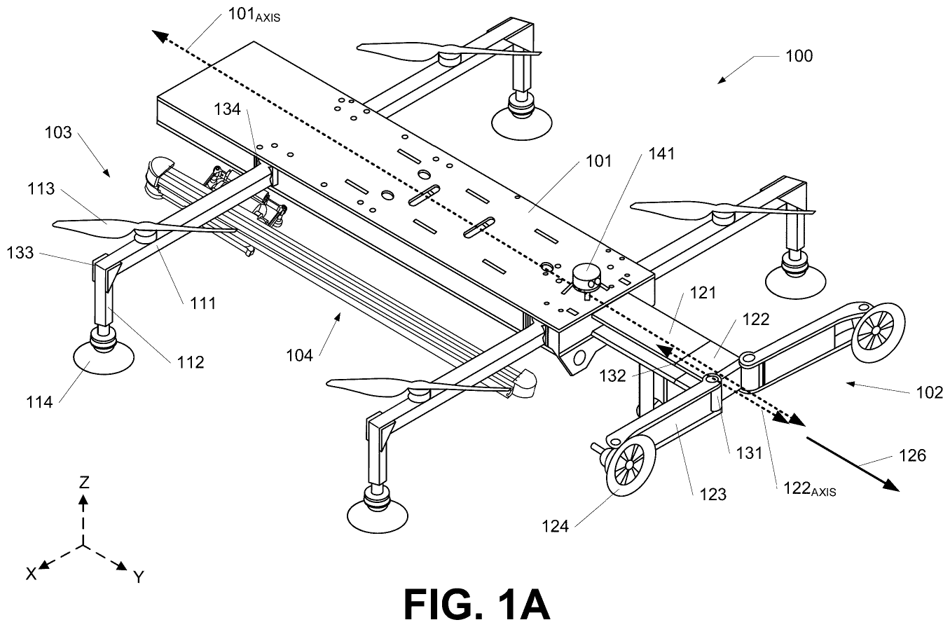

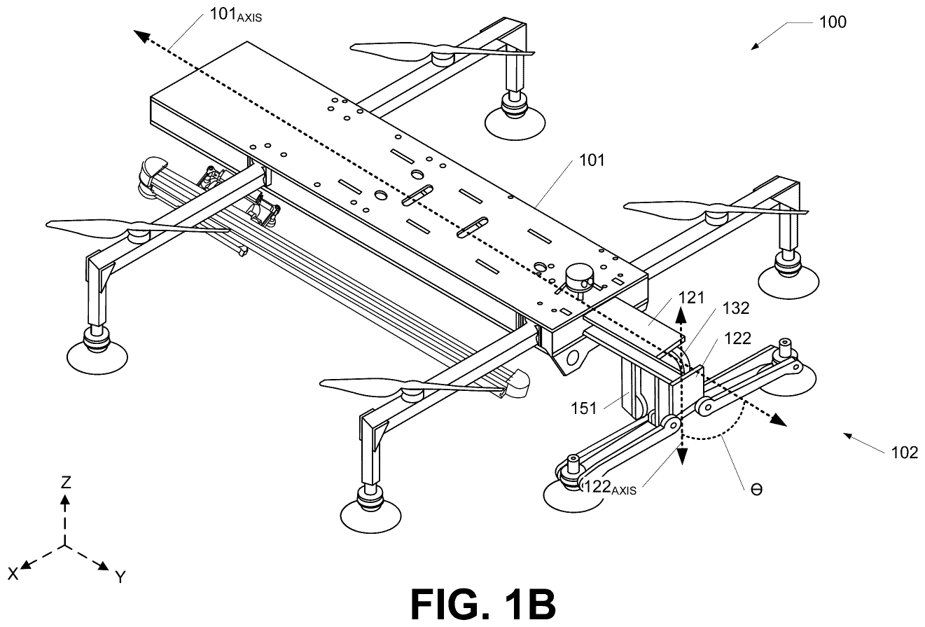

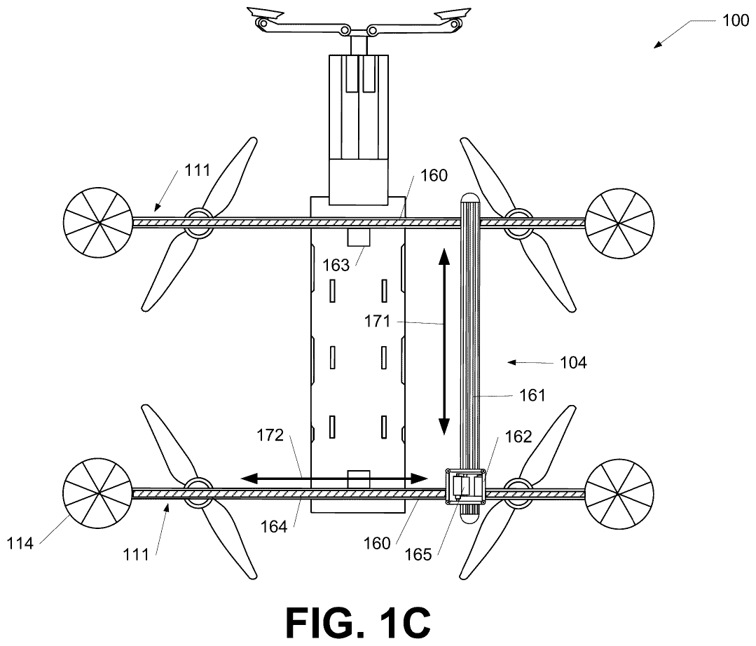

Referring now to the figures, for the purposes of example and explanation of the fundamental processes and components of the disclosed apparatuses, systems, and methods, reference is made to FIG. 1A, which illustrates an example unmanned aerial vehicle (UAV) 100. As will be understood and appreciated, the UAV 100 shown in FIG. 1 represents merely one approach or example of the present system, and other aspects are used according to various examples of the present system.

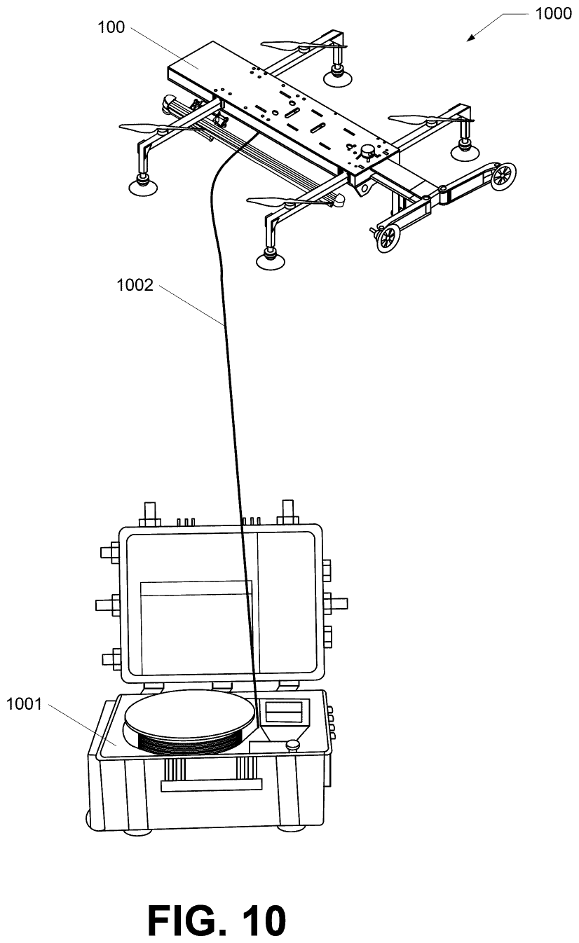

The disclosed technology includes UAV systems (e.g., systems including the UAV 100) capable of autonomous and/or controlled inspection and/or repair of physical structures (also referred to herein as “inspection targets”). Aspects of the disclosed technology are not limited to the specific examples provided herein; rather, any given example UAVs discussed herein can include one or more modifications, components, aspects, or the like discussed elsewhere herein with respect to another given example UAV. Stated differently and as discussed in further detail herein, the various examples illustrated and/or described herein are not intended to limit the scope of the innovation, and any combination of features can be made to provide a resulting UAV 100. Additional variations of the various UAV architectures described herein are contemplated and would not necessarily change the overall operating principles of the disclosed technology. For example, instead of being powered by a battery onboard the vehicle, the UAV can be powered via a tether connected to a battery on the ground, such as the tethered system (See FIG. 10). As another example, alternatively or in addition to the suction cup anchors, the UAV can include a magnetic anchor or mechanical gripper to anchor the UAV to the inspection target. These architectures are also generally agnostic to navigation sensor packages and flight control software.

The UAV 100 can be employed to inspect various inspection targets. Inspection targets can include but are not limited to buildings, wind turbines (both towers and blades), cell towers, power line poles, signs, billboards, and/or any other physical structure. For simplicity and illustration, the following discussion may focus on wind turbines, but the processes and systems described herein may apply to any physical structure. As discussed in further detail herein, the UAV 100 and/or any other disclosed UAV can autonomously and/or manually fly to the inspection target. The UAV 100 can include various systems and methods for attaching to the inspection target, moving along the inspection target, inspecting the inspection target, and/or flying to and from the inspection target. The UAV 100 can access difficult to reach inspection targets (e.g., offshore wind turbines) to aid technicians and other interested personnel in the inspection of the inspection targets. Alternatively or in addition, various UAVs 100 can be deployed to perform autonomous, manual, and/or remote inspection of inspection targets.

The UAV 100 can include a body 101, an anchor system 102, one or more leg structures 103, one or more rotor assemblies 113, and/or a gantry system 104. The body 101 can house electronic and computational systems capable of powering and controlling the UAV 100. For example, one, some, or all of the electronic and/or computational systems of the UAV 100 can be enclosed (or partially enclosed) within the body. Alternatively or in addition, one, some, or all of the electronic and/or computational systems of the UAV 100 can be attached to the body 101 of the UAV 100.

The body 101 can have any general shape. For example, as illustrated, the body 101 can have a substantially rectangular prismatic shape (e.g., a generally rectangular cross-sectional shape). As a non-limiting example, the body 101 can have a slender configuration (e.g., a thickness that is less than or equal to 50% of the smaller of the width or length, a thickness that is less than or equal to 33% of the smaller of the width or length, a thickness that is less than or equal to 25% of the smaller of the width or length, a thickness that is less than or equal to 20% of the smaller of the width or length, a thickness that is less than or equal to 15% of the smaller of the width or length, a thickness that is less than or equal to 10% of the smaller of the width or length), which can help reduce the overall weight of the UAV 100 and/or and increase flight efficiency. Alternatively or in addition, the body 101 can function as the central structure of the UAV 100 (e.g., one or more components of the UAV 100 can be affixed to, or extending from, the body 101).

The UAV 100 can include the anchor system 102 for anchoring to a particular inspection target. For example, the UAV 100 can fly to the inspection target and, while in the air, can approach the inspection target and bring at least a portion of the anchor system 102 into contact with a surface of the inspection target and/or can engage one or more vacuum suction cups 124. Accordingly, the UAV 100 can detachably attach (e.g., anchor) itself to the surface of the inspection target. Once anchored, the UAV 100 can perform one or more inspection operations of the inspection target (and/or perform one or more repair operations to the inspection target).

The anchor system 102 can include a base 121, an anchor arm hub 122, one or more anchor arms 123, and/or one or more anchor points, such as the illustrated vacuum suction cups 124. The anchor system 102 can include a vacuum system, which can include one or more vacuum devices (e.g., attached to the body 101, the anchor hub 122, or any other location on the UAV 100) (not shown) fluidly connected to the various vacuum suction cups 124 (e.g., via one or more tubes (not shown)). The vacuum system can be controlled (e.g., engaged, disengaged) to selectively and/or independently provide a suction force at the various vacuum suction cups 124. Alternatively or in addition, the vacuum system can be modulated to provide different suction forces at the vacuum suction cups 124, which can help ensure sufficient suction is provided to maintain attachment while anchored without expending excessive power to maintain attachment (e.g., conserving battery power).

The base 121 of the anchor system 102 can be or include a support extending outwardly from a front portion (e.g., a front side or face) of the UAV 100, such as from a front portion of the body 101 of the UAV 100. For example, a proximal end of the base 121 can extend and/or protrude from the body 101 (e.g., attached to the body, integral with the body 101), and a distal end of the base 121 can include an anchor arm hub 122 and/or can be attached to one or more anchor arms 123.

Either anchor arm 123 can extend outwardly (e.g., from the anchor arm hub 122 and/or base 121), and either anchor arm 123 can rotate or bend relative to the anchor arm hub 122 (e.g., in a direction that is toward or away from the engagement direction 126 shown in FIG. 1A). Accordingly, the anchor arms 123 can be configured to accommodate any uneven surfaces of a given inspection target, to help ensure multiple vacuum suction cups 124 (e.g., one or more vacuum suction cups 124 on either anchor arm 123) can fully engage the surface(s) of the inspection target and the UAV 100 can therefore become securely affixed thereto.

For example, a given anchor arm 123 can include an arm hinge 131. As illustrated, the anchor arm 123 can be attached to the anchor arm hub 122 via a corresponding arm hinge 131; stated differently, the arm hinge 131 can be located between anchor arm hub 122 and the anchor arm 123 such that a proximal end of the anchor arm 123 can be attached to the arm hinge 131. Alternatively or in addition, a given anchor arm 123 can include one or more arm hinges 131 at one or intermediate locations between the proximal and distal ends of the anchor arm 123. Alternatively or in addition, a given anchor 123 can include one or more hinges 131 that are configured to enable bending and/or rotation in one or more different directions. For example, a given anchor 123 can include one or more hinges configured to bend in the X-Y plane, one or more hinges configured to bend in the X-Z plane, and/or one or more hinges configured to bend in the Y-Z plane. Alternatively or in addition, a given anchor arm 123 can be composed of (and/or comprise) one or more materials having sufficient plasticity to bend (e.g., with or without any corresponding arm hinges 131), such as any plastic or composite material.

The anchor arms 123 can be configured to extend outwardly from a central axis of the body 101 of the UAV 100 (e.g., when the anchor arms 123 are “at rest” or not receiving or experiencing any outside forces). For example, the anchor arms 123 can extend outwardly in a direction that is approximately normal to the central longitudinal axis of the body 101 (e.g., when “at rest”). Alternatively or in addition, a given anchor arm 123 can be biased at least partially toward to the front or anchoring side of the UAV 100 (e.g., toward the engagement direction 126 illustrated in FIG. 1A). For example, a given anchor arm 123 can extend diagonally outward (e.g., in a direction that is partially normal to the central longitudinal axis of the body 101 and partially in the engagement direction 126). Alternatively or in addition, a given anchor arm can bend outwardly (e.g., in a direction that is partially normal to the central longitudinal axis of the body 101 and partially in the engagement direction 126).

Regardless of the specific configuration, the UAV 100 can be configured to fly to or otherwise approach an inspection target through the air and engage the anchor system 102 to the surface of the inspection target, thereby detachably attaching the UAV 100 thereto. More specifically, the independent hingeability (e.g., flexibility, rotatability) of each anchor arm 123 can enable one or more vacuum suction cups 124 of each anchor arm 123 to independently form a seal with a corresponding portion of the inspection target's surface (e.g., independent of the seal of another vacuum suction cup 124 and/or independent of the geometry of the portion of the inspection target's surface to which a given vacuum suction cup 124 is attaching relative to the geometry of any other portion of the inspection target's surface). This can enable a stronger securement or other anchoring effect at least in that the independent movement of the anchor arms 123 can permit the corresponding vacuum suction cups 124 to make complete (or as nearly complete as possible) contact between the perimeter of a given vacuum suction cup 124 and a corresponding portion of the inspection target's surface.

The anchor arms 123 can hinge about a first hinge 131 such that the arms adapt to the contours of the inspection target. Given that the vacuum suction cups 124 extend perpendicularly from the anchor arms 123, the anchor arms 123 can hinge to allow the vacuum suction cups 124 to properly press against and fix to the surface of the inspection target.

The UAV 100 can include a hinging mechanism 132. As illustrated, the hinging mechanism 132 can be located at an intermediate position along the base 121 of the anchor system 102 (e.g., a location closer to the proximate end of the base 121 than the anchor arm hub 122). Alternatively or in addition, the hinging mechanism 132 can be attached to (or at least partially integral with) the body 101 (e.g., without any portion of a base 121 being located therebetween). Regardless of the specific configuration, the hinging mechanism 132 can be included between the body 101 and the anchor arms 123.

The hinging mechanism 132 can be configured to selectively transition between an unhinged position and a hinged position. Considering a central plane extending through the length and width of the body 101 (e.g., in the X-Y plane shown in FIG. 1A) and an anchor arm plane corresponding to a central plane extending through the length and width of the anchor arm 123 (e.g., in the X-Z plane shown in FIG. 1A) (and/or a suction cup plane, which can correspond to a plane contacting the outer perimeter (e.g., the entire outer perimeter) of the vacuum suction cup 124), the unhinged position can correspond to the central plane of the body 101 intersecting (e.g., being normal, or approximately normal, to) the anchor arm plane and/or the suction cup plane (see FIG. 1A). In contrast, the hinged position can correspond to the central plane of the body 101 being parallel, or approximately parallel, to the anchor arm plane and/or the suction cup plane (see FIG. 1B).

Stated differently, and considering a central axis 122_{AXIS} of the anchor hub 122 (e.g., shown in FIG. 1A as extending approximately in the Y-direction and in FIG. 1B as extending approximately in the Z-direction) and the central longitudinal axis 101_{AXIS} of the body 101, the angle θ between the central axis 122_{AXIS} and the central longitudinal axis 101_{AXIS} can be greater when the hinging mechanism 132 is in the hinged position than when the hinging mechanism 132 is in the unhinged position. For example, when the hinging mechanism 132 is in the unhinged position, the angle θ can be zero (or approximately zero) (e.g., the central axis 122_{AXIS} and the central longitudinal axis 101_{AXIS} can be parallel, approximately parallel, and/or coaxial). When the hinging mechanism 132 is in the hinged position, the angle θ can be greater than zero. For example, when the hinging mechanism 132 is in the hinged position, the angle θ can be an acute angle (e.g., approximately 5°, approximately 10°, approximately 15°, approximately 20°, approximately 25°, approximately 30°, approximately 35°, approximately 40°, approximately 45°, approximately 50°, approximately 55°, approximately 60°, approximately 65°, approximately 70°, approximately 75°, approximately 80°, approximately 85°), a right angle (e.g., approximately 90°), or an obtuse angle (e.g., approximately 95°, approximately 100°, approximately 105°, approximately 110°, approximately 115°, approximately 120°, approximately 125°, approximately 130°, approximately 135°, approximately 140°, approximately 145°, approximately 150°, approximately 155°, approximately 160°, approximately 165°, approximately 170°, approximately 175°).

The hinging mechanism 132 can thus enable the body 101 to transition from a substantially parallel configuration relative to an engagement direction 126 of the anchor system 102 (the unhinged position) to the hinged position, in which an underside of the body 101 can be generally facing the surface of the inspection target (when the UAV 100 is anchored to the inspection target). Said differently, the hinging mechanism 132 can cause body 101 to hinge or rotate relative to the anchor arms 123 and/or the vacuum suction cups 124. The hinging mechanism 132 can include a locking portion and a hinging portion 122 (e.g., hinges).

The hinging portion 122 can be configured to transition the hinging mechanism 132 between the unhinged position and the hinged position, and the locking portion can be configured to selectively restrict movement of the hinging mechanism 132. For example, the locking portion can be or can include an electromagnet that, when engaged, can prevent rotation of the hinging portion 122 and can maintain the hinging portion 122 in the unhinged position. To transition from the unhinged position to the hinged position, the electromagnet can be released, thereby permitting the hinging portion 122 to rotate (and the body 101 to rotate relative to the anchor system 102). The speed of descent (e.g., the speed at which the UAV 100 transitions from the unhinged position to the hinged position) can be controlled by the rotor assemblies 113. To transition from the hinged position to the unhinged position, the rotor assemblies 113 can provide sufficient lift to rotate the body 101 about the hinging portion 122 until the electromagnet can reengage and maintain the hinging mechanism 132 (and the UAV 100) in the unhinged position.

Alternatively or in addition, the locking portion of the hinging mechanism 132 can be or can include an actuator that can be mounted on one side of the hinging portion 122 (e.g., on the body 101, the base 121, the anchor hub 122) and can extend to contact a receiving surface on the other side of the hinging portion 122 (e.g., on the body 101, the base 121, the anchor hub 122). Thus, when extended, the actuator can prevent rotation of the hinging portion 122, and when retracted, the actuator can permit rotation of the hinging portion 122.

Alternatively or in addition, the locking portion of the hinging mechanism 132 can be or can include a cable and pulley system, which can include a winch mounted on one side of the hinging portion 122 (e.g., on the body 101, the base 121, the anchor hub 122) and a cable that extends from the winch and is mounted to the other side of the hinging portion 122 (e.g., on the body 101, the base 121, the anchor hub 122). One or more pulleys can be included (e.g., proximate the hinging portion 122) to help avoid entanglement of the cable with any other components of the UAV 100 and/or foreign objects. The winch can keep the cable sufficiently taut to maintain the hinging mechanism 132 (and the UAV 100) in the unhinged position. To transition from the unhinged position to the hinged position, the winch can release or unroll the cable, and to transition from the hinged position to the unhinged position, the winch can retract or roll the cable, thereby providing tensile force from one side of the hinging portion 122 to the opposite side of the hinging portion and causing the hinging portion 122 to rotate closed.

Alternatively or in addition, the hinging mechanism 132 can be locked in place (e.g., in the unhinged position) during flight by a hinge locking device (e.g., a magnet and/or a spring-loaded latch, as non-limiting examples). Alternatively or in addition, the hinging mechanism 132 can be held in place (e.g., in the unhinged position) by a passive spring attached to either side of the hinging mechanism 132. The passive spring can have a spring force sufficient to hold the hinging mechanism 132 in the unhinged position, and after the anchor system 102 becomes attached to the inspection target surface and the rotor assemblies 113 are turned off (or controlled to decrease the rotor assemblies'113 thrust), the weight of UAV 100 can overcome the spring holding force of the passive spring, such that the UAV 100's body 101 rotates about the hinging mechanism 132 relative to the anchor system 102. Upon the anchor system 102 releasing from the inspection target's surface, the rotor assemblies 113 can generate lift to navigate the UAV 100 away from the inspection target's surface, and the removal of the UAV's 100 weight from the passive spring can permit the tension of the passive spring to transition the hinging mechanism 132 from the hinged position to the unhinged position.

Regardless, the UAV 100 can include a stop arm 151, which can be an arm, protrusion, or other structure extending from a portion of the UAV 100 on one side of the hinging portion 122 and configured to contact and/or abut a portion of the UAV on the opposite side of the hinging portion 122 at a maximum hinging angle of the hinging mechanism 132. For example, as illustrated, the stop arm 151 can extend from an underside of the base 121 and can abut an underside of the anchor hub 122 when the hinge mechanism 132 has reached its maximum hinge angle.

Regardless, the hinging mechanism 132 can allow the body 101 to transition from a substantially perpendicular configuration relative to the surface of the inspection target to a substantially parallel configuration relative to the surface of the inspection target. Accordingly, the UAV 100 can hang from the anchor system 102 to position the body 101 over a location of interest on the surface of the inspection target, thereby enabling one or more sensors on the underside of the UAV 100 to inspect the inspection target (and/or enabling any repair devices there located to perform repair operations to the inspection target). For example, the UAV 100 can include a gantry system 104 mounted to, or otherwise extending from, the underside of the body 101, and in the hinged position, the gantry system 104 can be in a generally parallel configuration relative to the surface of the inspection target. Stated differently, when the UAV 100 is in the hinged position, the gantry system 104 (and any sensors or repair devices mounted thereon) can be positioned over, and/or provided physical access to, a location of interest on the surface of the inspection target.

Though illustrated as vacuum suction cups 124, the anchor points can, alternatively or in addition to the vacuum suction cups 124, include any particular attachment system or device. For example, the anchor points can include one or more electromagnetic engagement systems (e.g., for detachably attaching to ferromagnetic materials), one or more adhesive materials (e.g., having adhesion qualities to provide adhesion to the surface of the inspection target that is strong enough to maintain the weight of the UAV 100 and weak enough to be selectively broken, such as by forces imparted by the rotor assemblies 113), one or more other temporary attachment systems or devices, or any combination thereof. Similarly, it is to be understood that discussion herein of any other vacuum suction cup (e.g., a leg vacuum suction cup 114) can, alternatively or in addition, be or include any such attachment system or device or any combination thereof.

Alternatively or in addition, the UAV 100 can include one or more magnets (e.g., attached to one or more legs 112), an active down-force generation system (e.g., an airflow and/or suction system, such as is described in WO 2022/129886, WO 2019/229471, or any systems similar thereto), and/or any other attachment devices or system to adhere the UAV 100 to the inspection target while allowing for lateral movement (e.g. via a wheeled propulsion system). In some implementations, the adhesive force can be sufficient to allow the UAV 100 to climb up vertical surfaces or even hang upside-down beneath an overhang or horizontal surface. This system could require less power than flying, while maintaining stable contact with the dock surface. In such a configuration, the UAV 100 can include a fixed sensor and can simply drive over the locations to be inspected, without including a gantry system 104. Alternatively, such a configuration of the UAV 100 can include the gantry system 104 and/or a robotic arm on which the sensor(s) (e.g., NDT sensor) can be mounted.

The UAV 100 can include one or more rotor assemblies 113, and the one or more rotor assemblies 113 can be mounted to one or more leg structures 103. The rotor assemblies 113 can generate lift and enable the UAV 100 to fly. While illustrated as being mounted to the leg structures, the rotor assemblies 113 can be mounted or otherwise affixed to any location on the UAV 100 (e.g., the body 101).

As non-limiting examples, the UAV 100 can include three, four, or more leg structures 103. Alternatively or in addition, the UAV 100 can include one or more legs 112, such as one or more legs 112 extending from each leg structure 103. The legs 112 can be positioned to provide stability to the UAV 100 when the legs are contacting a surface (e.g., a surface of the inspection target, a landing surface such as the ground), and each leg 112 can be sufficiently long to ensure the gantry 104 and/or other components (e.g., the anchor system 102, sensors, repair tools) are suspended from a surface contacted by the legs 112. Each leg structure 103 can include a frame 111 and a leg 112. The frame 111 can extend outwardly (e.g., perpendicularly) from the body 101 (e.g., to provide room therebetween for the gantry system 104 to operate). Alternatively or in addition, the frames 111 of pairs of opposing leg structures 103 (e.g., located on opposite sides of the central longitudinal axis 101_{AXIS}) can support or include rails of the gantry system 104 (e.g., as shown in FIG. 1C). Stated differently, the frames 111 of opposing leg structure 103 can connect to, or be integral with, one another and can extend continuously through the body 101, and/or the frames 111 of opposing leg structure 103 can support (e.g., suspend) a continuous track or rail of the gantry system 104.

Alternatively or in addition, the frame 111 can extend from a joint 134 of the body 101, and the frame 111 can be configured to hinge, rotate, and/or otherwise move about the joint 134 and/or relative to the body 101. For example, the joint 134 can include a hinging device (e.g., comprising a hinging portion and/or locking portion, similar to those described with respect to the locking mechanism 132). The legs 112 can each extend perpendicularly from the corresponding frames 111. A given leg 112 can be statically attached to the corresponding frame 111, or the leg 112 can be moveably attached to the corresponding frame 111 at a hinge point 133 (e.g., comprising a hinging portion and/or locking portion, similar to those described with respect to the locking mechanism 132).

The UAV 100 (e.g., the one or more leg structures 103) can include a suspension system. For example, the UAV 100 can include one or more suspension systems (e.g., one for each leg structure 103), which can include a joint 134, a hinge point 133, and/or one or more suspension components. The one or more suspension components can be configured to provide tension and/or compression (e.g., one or more coil springs, one or more leaf springs, one or more torsion bars, one or more shock absorbers or struts). Accordingly, the suspension system can enable the one or more leg structures 103 to accommodate an uneven surface (e.g., the surface of the inspection target, uneven ground terrain). Alternatively or in addition, a leg structure (or any component thereof, such as the frame 111 and/or the leg 112) can be composed of (and/or comprise) one or more materials having sufficient plasticity to bend (e.g., with or without any corresponding joints 134, hinge points 133, or the like), such as any plastic or composite material.

The suspension system and/or the bendable leg structure(s) 103 can enable the UAV 100 to take off and/or land on uneven ground surfaces and/or to contact, abut, and/or attach to the uneven (e.g., curved) surface(s) of a given inspection target (e.g., when the anchor system 102 is in the hinged position). For example, the legs 112 can automatically hinge at the hinge point 133 (or bend relative to the body 101) to accommodate variations in the surface of the inspection target (e.g., the blade of the wind turbine) or any other surface.

A given leg 112 can include a leg vacuum suction cup 114. The leg vacuum suction cup(s) 114 can function in the same, or a substantially similar, manner as the vacuum suction cups 124. The leg vacuum suction cup(s) 114 can be powered by a dedicated vacuum system or can be powered by the same vacuum system powering the vacuum suction cups 124. In the case of a common vacuum system, the UAV 100 can include valves (e.g., solenoid valve, miniature solenoid valve) to selectively provide suction to one or more particular vacuum suction cups 124 and/or one or more particular leg vacuum suction cups 114. The leg vacuum suction cup(s) 114 can help secure the UAV 100 to the surface of the inspection target. The leg vacuum suction cups 114 can change angular orientations about the base of the leg 112 (e.g., can be mounted on to the leg 112 via a joint, gimbal, or the like) to promote flush contact between the leg vacuum suction cups 114 and the surface on which the UAV 100 is landing. To that end, any given vacuum suction cup discussed herein (e.g. leg vacuum suction cup 114, vacuum suction cup 124) can be mounted on a gimbal (e.g., a two-axis gimbal), which can ensure that the entire rim (e.g., perimeter) of the cup makes contact with the surface.

The vacuum system can include one or more pumps (e.g., a miniature diaphragm pump with separate pump heads for each vacuum cup) and/or can be configured to ensure each cup can independently hold a vacuum. For example, the vacuum system can include one or more micro-electromechanical systems (MEMS) pressure sensors, which can be connected to each circuit to monitor the pressure and thereby detect whether a given cup is holding vacuum. Vacuum pressure within a given vacuum cup (e.g. leg vacuum suction cup 114, vacuum suction cup 124) can be released or prevented, as desired, using one or more valves (e.g., one or more miniature solenoid valves).

The UAV 100 can include one or more navigation sensors 141. The navigation sensor(s) 141 can include one or more sensors configured to capture data for determining a current position or location of the UAV 100, detecting environmental objects around or near the UAV 100, or detecting proximity of the UAV 100 to the inspection target, as non-limiting examples. The navigation sensor(s) 141 can include, as non-limiting examples, one or more visible spectrum cameras, one or more LiDAR scanners, one or more infrared sensors, one or more ultrasonic sensors, one or more geolocation sensors, one or more magnetometers, one or more IMUs (e.g., accelerometer(s) and/or gyroscope(s)), or other sensors, or any combination thereof. Each navigation sensor 141 can capture corresponding navigation sensor data and can provide the captured navigation sensor data to the controller, which can be configured to determine, based at least in part on the navigation sensor data, the current position of the UAV 100 (e.g., relative to the inspection target), one or more projected future positions of the UAV 100, a projected travel path of the UAV 100, or the like. For example, the navigation sensor(s) 141 can include one or more cameras (e.g., one or more stereo cameras, one or more depth cameras), one or more light detection and ranging (LiDAR) systems (e.g., one or more point LiDAR systems, one or more scanning LiDAR systems), one or more geolocation sensors or devices (e.g., one or more global positioning system (GPS) absolute positioning systems, one or more global navigation satellite system (GNSS)), or any combination thereof. As a non-limiting example, the UAV 100 can include both a scanning LiDAR system and a visible-spectrum camera. The camera can be configured to collect reference images, and the UAV 100 (e.g., the controller of the UAV 100) can transmit the reference images to a user controller or other computing device, such as for a pilot or other user to view. As the UAV 100 approaches the inspection target, the reference images can illustrate a target dock position on the inspection target and/or at least a portion of one or more attachment assemblies of the UAV 100 (e.g., the anchor system 102). Alternatively or in addition, the controller (or another computing device) can analyze the reference images to determine whether the UAV 100 is on course (e.g., at a desired location or following a desired path) and/or determine any corresponding corrective actions if the UAV 100 is off-course. The controller (or another computing device can transmit any such determinations to the user controller or other computing device (e.g., a controller operated by the pilot and/or an automated system).

The scanning LiDAR can collect LiDAR data and provide the LiDAR data to the controller. The controller can be configured to determine the UAV's 100 position relative to the inspection target and/or determine a surface normal vector orientation. The surface normal vector can be a vector that points perpendicular to the inspection target surface at a particular location. The scanning LiDAR can provide a constant or near-constant stream of data or data pairs (e.g., distance, angle) corresponding to the measured distance from the UAV 100 to the target and the angle at which the scanning LiDAR was pointing at that instant. The controller can be configured to continuously fit the inspection target surface to these values to thereby determine orientation. Alternatively or in addition, a different type of LiDAR can be used to provide a cloud of points (“point cloud”) representing all the objects detected by the LiDAR system around or near (e.g., in front of) the UAV 100.

Referring now to FIG. 1C, a bottom view of the UAV 100 is illustrated, in accordance with the disclosed technology. As discussed elsewhere herein, the gantry system 104 can be mounted to an underside of the UAV 100, and one or more sensors (and/or one or more repair tools) can be mounted to the gantry system 104. Accordingly, the gantry system 104 can move the sensor(s) (and/or repair tool(s)) relative to the body 101. As such, the gantry system 104 can move the sensor(s) (and/or repair tool(s)) relative to inspection target when the UAV 100 is anchored to the inspection target. The gantry system 104 can include one or more tracks 160 (e.g., two opposing tracks 160, which can each be mounted to, or integral with, a pair of frames 111), a gantry arm 161 configured to traverse the track(s) 160, and a carriage 162 configured to traverse the gantry arm 161. The gantry arm 161 can be approximately perpendicular to the track(s) 160. Accordingly, the carriage 162 can be configured to traverse within a two-dimensional area (e.g., as defined by the lengths of the track(s) 160 and the gantry arm 161). The carriage 162 can include one or more sensors 165 (e.g., one or more NDT sensors), one or more repair tools, or any combination thereof.

The gantry system 104 can include one or more motors 163 for traversing one or more components of the gantry system. For example, one or more first motors 163 (e.g., mounted to, or located within, the carriage 162) can be configured to traverse the carriage 162 along the gantry arm 161 (e.g., along a first axis 171 of the two-dimensional space), and/or one or more second motors 163 can be configured to traverse the gantry arm 161 along the track(s) 160 (e.g., along a second axis 172 of the two-dimensional space). The gantry system 104 can include one or more belts 164 (e.g., driven by one or more corresponding motors 163). For example, to move the gantry arm 161 along the second axis 172, the gantry system 104 can include one or more belt motors 163 (e.g., attached to the frame 111) and one or more belts 164 (e.g., a belt 164 located on or within a track 160 corresponding to a frame 111 or pair of frames 111). The gantry arm 161 can be attached to the belt and can be moved relative to the body 101 as the belt 164 is moved by the motor 163. As illustrated, either end of the gantry arm 161 can be attached to a corresponding belt 164, although other configurations are contemplated. Similarly, the gantry arm 161 can include a belt 164 disposed therein and movement of the carriage 162 relative to the gantry arm 161 can be effected by moving the belt 164 via a corresponding motor 163.

Alternatively or in addition, the motor(s) 163 can power one or more wheels. For example, the carriage 162 can include one or more motorized wheels configured to traverse along a predefined path along the gantry arm 161, and/or the gantry arm 161 can include one or more motorized wheels configured to traverse along a predefined path along the track(s) 160.

The carriage 162 can include a telescoping structure that can extend or retract a given sensor 165 or tool in a direction normal to the two-dimensional area navigable by the gantry system 104. Alternatively or in addition, the leg structures 103 (e.g., the legs 112) can each include a telescoping structure that can extend or retract a given sensor 165 or tool in a direction normal to the two-dimensional area navigable by the gantry system 104 (e.g., the plane defined by the first axis 171 and the second axis 172); stated differently, the legs 112 can be telescopic legs configured to extend or retract and thereby selectively increase or decrease the current length of a particular leg 112. Accordingly, the UAV 100 can be configured to selectively place a given sensor 165 or tool in close proximity to, or in contact with, the surface of the inspection target.

The UAV 100 can include a rotation device (e.g., a stepper motor) located between the hinging mechanism 132 and the anchor arms 123. For example, the illustrated anchor hub 122 can be separated into a first hub portion proximate the anchor arms 123 (e.g., closer to the anchor arms 123 than the hinging mechanism 132) and a second hub portion proximate the hinging mechanism 132 (e.g., closer to the hinging mechanism 132 than the anchor arms 123). The rotation device can have a base portion (e.g., a non-rotating base), a rotatable portion (e.g., a shaft), and a motor configured to rotate the rotatable portion relative to the base portion. The base portion can be attached to the first hub portion, and the rotatable portion can be attached to the second hub portion. Alternatively, the base portion can be attached to the second hub portion, and the rotatable portion can be attached to the first hub portion. Regardless, the rotation device can be configured to rotate the body 101 relative to the anchor portion and/or about a rotational point of the anchor portion. Accordingly, when the anchor system 102 is engaged (e.g., the UAV 100 is anchored to the inspection target), any leg vacuum suction cups 114 can be disengaged and the rotation device can rotate the UAV 100 from a first rotational position relative to the anchor location of the anchor system 102 to a second, different rotational position relative to the anchor location of the anchor system 102. That is to say, the rotational device can enable the UAV 100 to inspect (or repair) 360° about the anchor location (e.g., a ring-shape inspection area) without disengaging the anchor system 102.

The UAV 100 can include any type of sensor 165 (e.g., NDT sensors) or combinations of sensors 165. For example, the UAV 100 can include one or more thermography sensors, one or more X-ray sensors, one or more ultrasound sensors, one or more microwave sensors, one or more infrared sensors or cameras, one or more visual cameras, and/or one or more laser scanning sensors, among others. Ultrasonic scanners can be useful for revealing the internal structure of an inspection target by analyzing the reflection of acoustic waves from an ultrasound transducer. Infrared sensors (e.g., infrared cameras) can detect the thermal profile of the inspection target, which has been shown to reveal defects in some cases. Alternatively or in addition, the UAV 100 can include any type of repair tool, or combinations of repair tools, such as one or more grinders; one or more sanders; one or more vacuums; one or more saws; one or more liquid applicators, dispensers, and/or injectors; one or more tape dispensers and/or applicators; one or more drills; one or more liquid sprayers (e.g., for cleaning); one or more heat guns; one or more heating elements; one or more air sprayers, one or more screwdrivers, or the like, or any combination thereof.

The UAV 100 can include a plurality of sensor modules (e.g., modules having a common attachment mechanism and each including a different type of sensor 165 or combination of sensors 165), and the carriage 161 can include one or more receivers each configured to detachably attach to any one of the plurality of sensor modules. Accordingly, the sensors 165 can be modularly configured to thereby provide easily swappable sensors 165 and/or sensor configurations, meaning that different sensors can be easily attached to the UAV 100 or detached from the UAV 100 for different missions and/or for performing different inspection operations and/or repair operations (e.g., based on the inspection target or characteristics thereof, based on environmental conditions). This can enable the UAV 100 to be employed in a wide variety of inspection missions and/or for different types of inspection targets (e.g., wind turbine blades, bridges, rockets and launch platforms).

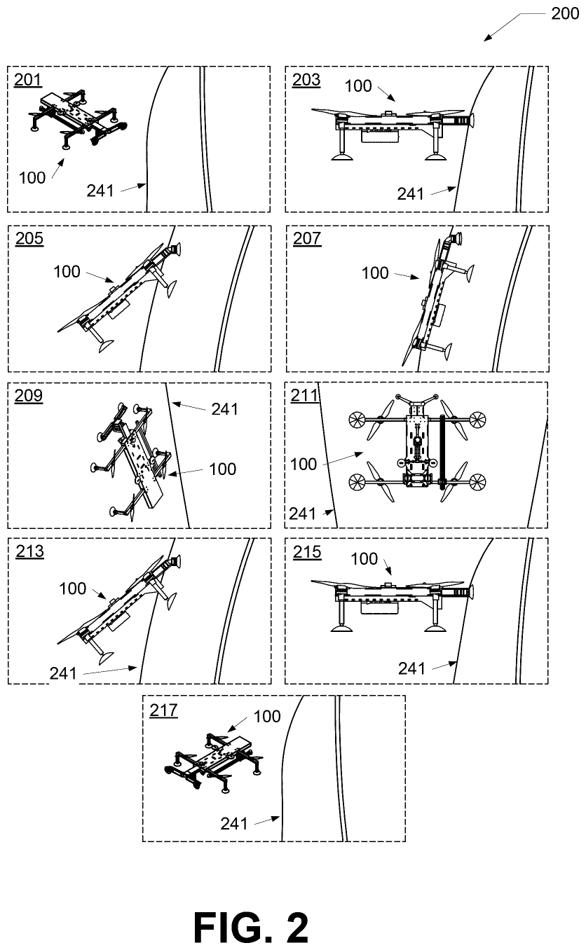

Referring now to FIG. 2, an example inspection process performed by the UAV 100 is shown. The inspection target illustrated in FIG. 2 is a wind turbine blade 241. Frame 201 shows the UAV 100 flying toward the wind turbine blade. As discussed more fully herein, the UAV 100 can be configured to autonomously fly, such as autonomously navigating to the wind turbine blade 241 and/or autonomously approaching and anchoring to the wind turbine blade 241. Alternatively, the UAV 100 can be configured to be remotely controlled by a pilot (e.g., via a remote user device).

Frame 203 depicts the UAV 100 contacting and anchoring to the surface of the wind turbine blade 241 (e.g., via the anchor system 102). For example and as discussed more fully herein, the UAV 100 can include one or more navigation sensors 141 and a controller to navigate and/or anchor to the wind turbine blade 241. The anchor system 102 can include one or more pressure sensors to identify that the vacuum suction cups 124 are adequately pressed against the surface of the wind turbine blade 241. For example, pressure sensor(s) can determine the pressure in or associated with each vacuum suction cup 124, which can be used to confirm whether each vacuum suction cup 124 currently has vacuum. To help conserve power, the pump system can deactivate when the pressure (e.g., in all vacuum suction cups 124, in a predetermined number or percentage of the vacuum suction cups 124) is below a predetermined threshold pressure (e.g., the “off threshold”). The pressure sensor(s) can continue to monitor the pressure and/or vacuum in the vacuum suction cup(s) 124, even while the pump system is deactivated. If the pressure sensor(s) detect the current pressure as being greater that an “on threshold” (e.g., the same threshold as the off threshold, a threshold value greater than the off threshold, a threshold value less than the off threshold) (which can be due to a small leak, for example), the pump system can be re-activated until the current pressure decreases to below the off threshold again.

Frames 203, 205, and 207 show the hinging action of the hinging mechanism 132 and the incremental transition of the UAV 100 from the unhinged position (e.g., the body 101 of the UAV 100 being generally perpendicular to the surface of the wind turbine blade 241) to the hinged position (e.g., the body 101 of the UAV 100 being generally parallel to the surface of the wind turbine blade 241). While anchored (e.g., via the vacuum system) and in the hinged position, the UAV 100 can disengage the rotor assemblies 113 (e.g., to conserve battery power) while the gantry system 104 and any sensors or tools attached thereto are engaged to measure or repair various features, characteristics, aspects, or the like of the wind turbine blade 241.

Frames 209 and 211 show different views of the UAV 100 performing an inspection operation on the surface of the wind turbine blade 241.

Frames 213-217 illustrate the hinging mechanism 132 returning to the unhinged position (e.g., by engaging the rotor assemblies 113) and navigating away from the docking and/or inspection location (e.g., leaving the wind turbine blade 241 or moving to another docking and/or inspection location on the wind turbine blade 241). The UAV 100 can be returned to the unhinged position prior to releasing the anchor system 102 from the inspection target (e.g., if the rotor assemblies 113 are alone responsible for transitioning the UAV 100 from the unhinged position to the hinged position). Alternatively, the UAV 100 can release the anchor system 102 from the inspection target prior to fully returning to the unhinged position (e.g., if the rotor assemblies 113 are sufficiently engaged to support the weight of the UAV 100; if the UAV 100 includes an actuator, cable and pulley system, or the like for transitioning the UAV 100 from the unhinged position to the hinged position).

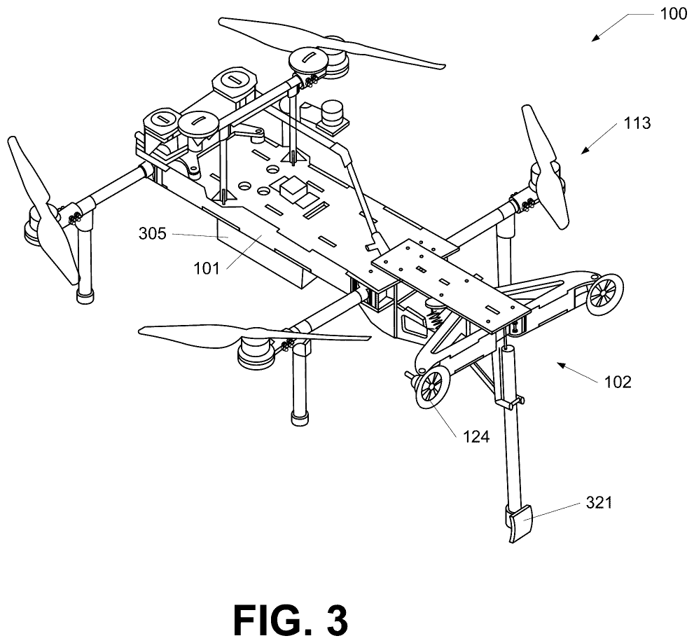

Referring now to FIG. 3, the UAV 100 can exclude a hinging mechanism (e.g., hinging mechanism 132) and can inspect (or repair) the inspection target without hinging. For example, the UAV 100 can include an anchor system 102 (e.g., the same as, or similar to, anchor system 102) and one or more stabilizing legs 321. The stabilizing leg(s) 321 can be a rigid pole or other structure, can be mounted on or to the front of the UAV 100, and/or can extend outwardly from the mounting location (e.g., downwardly with respect to the body 101), as non-limiting examples. A proximate end of a given stabilizing leg 321 can be mounted to the body 101, the anchoring system 102, or the like, and a distal end of the stabilizing leg 321 can include a contact pad. The stabilizing leg(s) 321 can be statically attached to the body 101 (or any other location of the UAV 100). Alternatively or in addition, the stabilizing leg(s) 321 can be hingedly and/or rotatably connected to the body 101, such that the stabilizing leg(s) 321 can transition between a retracted position (e.g., folded underneath the body 101, such as when a given stabilizing leg 321 is approximately parallel to the body 101) and an extended position (e.g., extending from the mount location, such as is shown in FIG. 3 and/or such that a given stabilizing leg 321 is approximately perpendicular to the body 101).

The contact pad can be configured to abut a lower portion of the surface of the inspection target when the anchor system 102 (e.g., vacuum suction cups 124) is attached to an upper portion of the surface of the inspection target. Thus, once the UAV 100 is anchored via the anchor system 102, the rotor assemblies 113 can be disengaged (e.g., to conserve battery life), and the weight of the UAV 100 (which is extended from the surface via the anchor system 102) can experience a moment force extending down and toward the inspection target's surface, thereby causing the contact pad to become pressed against the lower portion of the inspection target's surface. As such, the rigid stabilizing leg 321 can support the weight of the UAV 100 and maintain the UAV in a stable position while various sensors 165 or tools perform corresponding inspection operations and/or repair operations. Stated differently, the anchor system 102 can attach or anchor the UAV 100 to the surface (e.g., an upper portion of the surface) of the inspection target, and the stabilizing leg 321 can mitigate the cantilever moment experienced by the UAV 100 while anchored, to thereby enable the UAV 100 to remain roughly level (e.g., the body 101 of the UAV 100 can be maintained in a position that is approximately parallel to ground).

The UAV 100 can include one or more sensors 165, such as via one or more robotic arms (e.g., one or more actuators), which can be mounted to the body 101 (e.g., the underside of the body 101), the stabilizing leg 324, or elsewhere. Alternatively or in addition, the UAV 100 can include a gantry system 104, which can include one or more (e.g., two) vertical tracks 160, a gantry arm 161 (e.g., perpendicularly oriented with respect to the track(s) 160) configured to traverse the track(s) 160, and a carriage 162 configured to traverse the gantry arm 161. The track(s) 160 can extend from the body 101 and/or the anchor system 102. Alternatively or in addition, the stabilizing leg(s) 321 can be or can include the track(s) 160, such that the gantry arm 161 can be configured to traverse along at least a portion of the stabilizing leg(s) 321. As discussed elsewhere herein, the carriage 162 can hold any combination of sensors 165 and/or tools. Alternatively or in addition, the UAV 100 can include an NDT scanner 305 or other sensor(s) (or repair tool(s)) can be mounted to the underside of the UAV 100. The UAV 100 can include other sensors, computing components, and/or navigation systems located on top of the body 101 of the UAV 100.

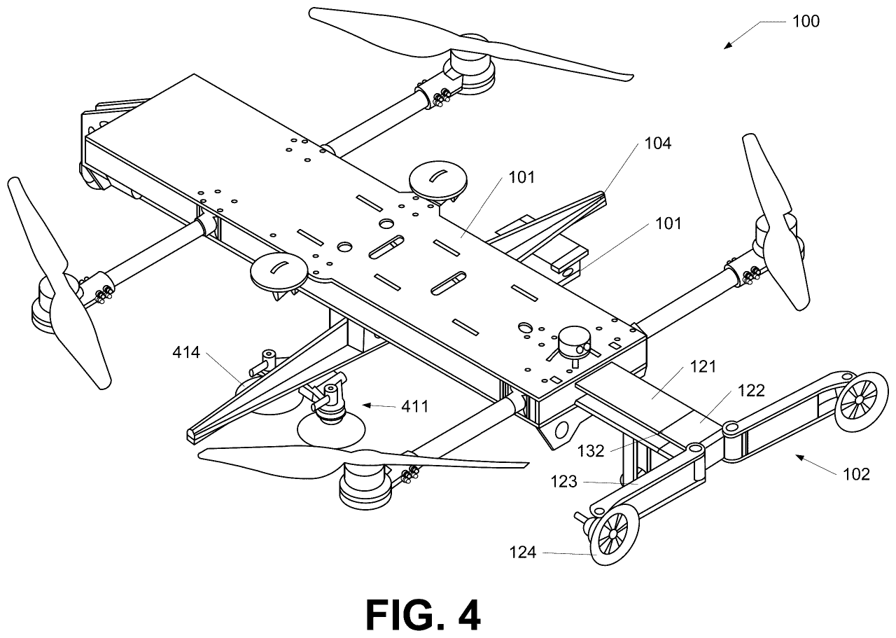

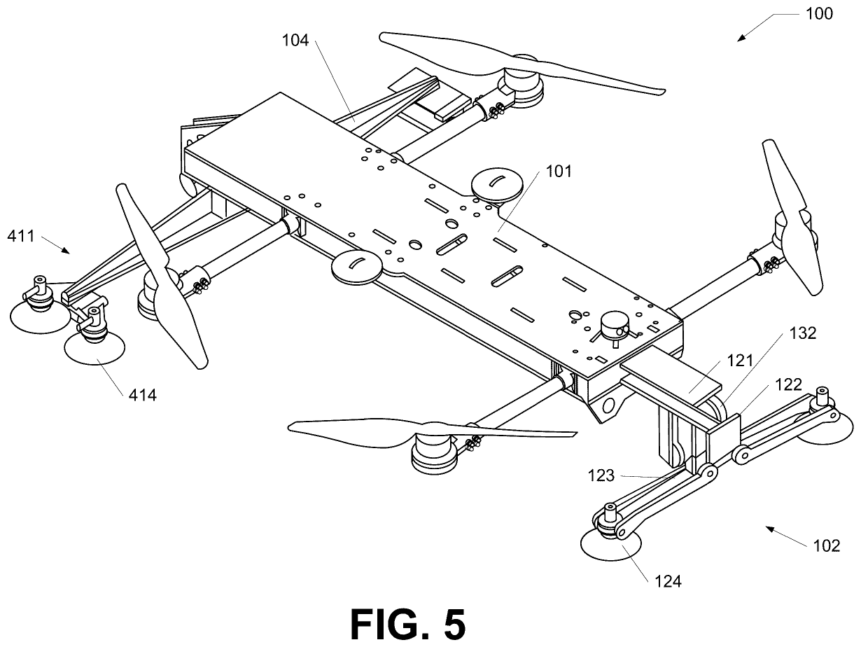

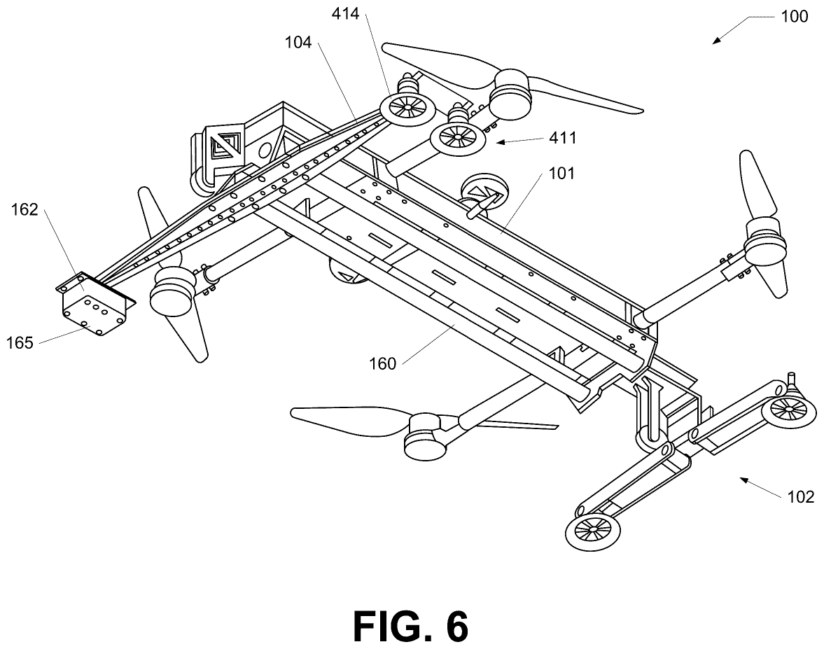

Referring now to FIGS. 4-6, the UAV 100 can include the hinging mechanism 132 and the anchor system 102. As discussed more fully herein, the hinging mechanism 132 can transition between an unhinged position (e.g., the body 101 of the UAV 100 is approximately perpendicular to the attachment surfaces of the vacuum suction cups 124 of the anchor system 102, such as is depicted in FIG. 4) and a hinged position (e.g., the body 101 of the UAV 100 is approximately parallel to the attachment surfaces of the vacuum suction cups 124 of the anchor system 102, such as is depicted in FIGS. 5 and 6). As discussed more fully herein, the hinging mechanism 132 can be located between the attachment points of the anchor system 102 and the body 101 and can thereby hinge to bring the body 101 of the UAV 100 generally parallel to the surface of the inspection target when the UAV 100 is anchored to the inspection target.

The UAV 100 can include the gantry system 104 mounted to the underside of the body 101, and a scanning actuator and/or one or more sensors can be mounted to the gantry system 104. A benefit of this architecture (e.g., inclusion of the hinging mechanism) is an increased rigidity and stability of the scanning actuator and/or sensors (e.g., if/when the sensor(s) and/or scanning actuator are mounted on the underside of the UAV 100).

Alternatively or in addition, a secondary attachment assembly 411 comprising one or more secondary vacuum suction cups 414 (or other attachment points) can be mounted to the gantry system 104. The secondary attachment assembly 411 can enable the UAV 100 to traverse along the inspection target surface without needing to fully disengage from the inspection target, which can help conserve power, expedite scanning (particularly large areas), and seamlessly stitch together large surface scans. For example, the UAV 100 can be configured to anchor to the inspection target's surface via the vacuum suction cups 124 of the anchor system 102 and transition to the unhinged position, as more fully discussed elsewhere herein. As the UAV 100 transitions to the unhinged position, the secondary vacuum suction cups 414 can contact a lower portion of the inspection target's surface (e.g., as compared to the upper portion of the inspection target's surface at which the vacuum suction cups 124 are attached). The UAV 100 can then release the vacuum suction cups 124 from the upper portion of the inspection target's surface, causing the gantry arm 161 of the gantry system 104 to traverse in either direction along the track(s) 160 (e.g., in either direction along the longitudinal central axis 101_{AXIS} of the UAV 100). Accordingly, the UAV 100 can be translated up or down in relation to the original anchor location of the vacuum suction cups 124. Alternatively or in addition, the gantry system 104 of the UAV 100 can include the carriage 162, and the secondary vacuum suction cups 414 can be attached to the carriage. As the carriage 162 translates along the gantry arm 161, the UAV 100 can translate in either direction along the gantry arm 161 (e.g., in either direction perpendicular to the central longitudinal axis 101_{AXIS} of the UAV 100). The UAV 100 can be translated left or right in relation to the original anchor location of the vacuum suction cups 124. Once the gantry system 104 has moved the UAV 100 to the next location of interest, the vacuum suction cups 124 of the anchor system 102 can be re-engaged to a new anchor location (and the secondary vacuum suction cups 414 can be disengaged), and the process can be restarted.

FIG. 6 shows a bottom view of the UAV 100. As illustrated, the secondary attachment assembly 411 and one or more sensors 165 can be mounted to the gantry system 104. The track(s) 160 of the gantry system 104 can be or include one or more rails. The gantry system 104 can be configured to slide or otherwise move along the rails (e.g., the tracks 160), such as by an actuator, drive wheel, or other mechanism or device configured to move the gantry system 104 along the rails.

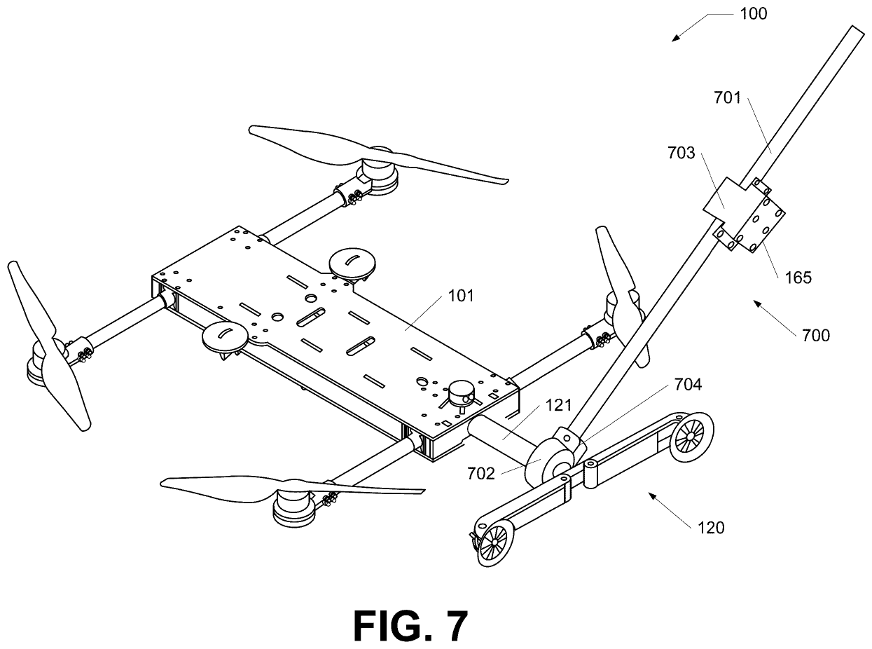

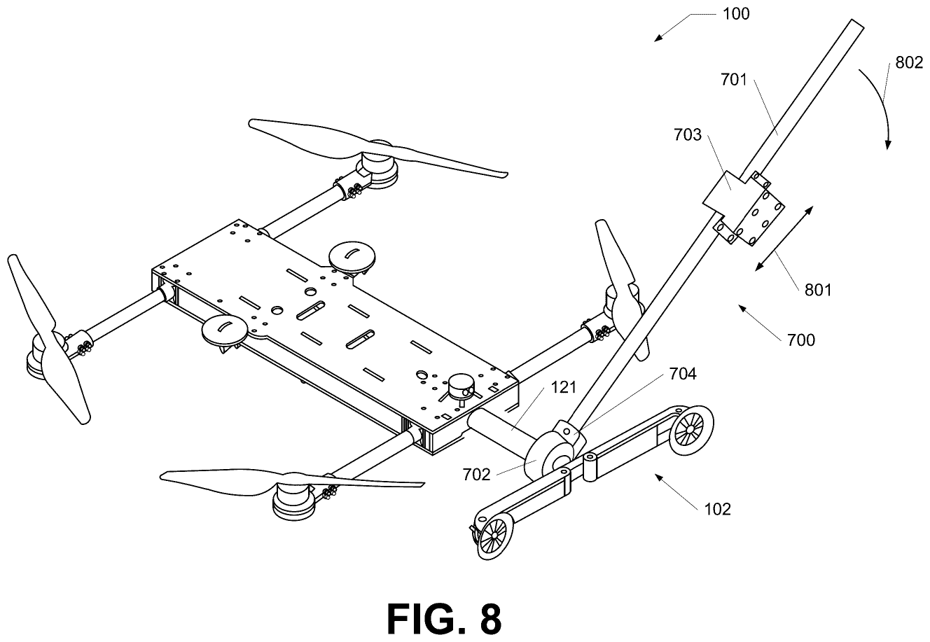

Referring now to FIGS. 7-9, the UAV 100 can include a polar gantry system 700 (alternatively or in addition to various other components, implementations, or architectures discussed herein, such as the gantry system 104). The polar gantry system 700 can include a scanning arm 701, which can be or include a pole or other rigid structure, and a collar 702 configured to selectively rotate the scanning arm 701 relative to the body (e.g., in a clockwise direction 802, as shown in FIG. 8, or in a counter-clockwise direction). The collar 702 can be attached to the base 121 (which can have a tubular shape as shown in FIG. 7-9, a rectangular and/or I-beam shape (e.g., as shown in FIGS. 1A and 1B), or any other shape) of the anchor system 102 as depicted, or the collar 702 can be attached to the body 101, the anchor arm hub 122 of the anchor system 102, or any other location. The polar gantry system 700 can include a carriage 703 (e.g., having the same or similar functionalities and/or components as carriage 165 of the gantry system 104) slidably attached to the scanning arm 701, and the carriage 703 can have one or more sensors 165 (e.g., one or more NDT sensors) and/or repair tools attached thereto. The polar gantry system 700 can include one or more motors (e.g., one or more stepper motors, one or more motorized wheels). For example, the collar 702 can include one or more motors configured to rotate the polar gantry system (e.g., the scanning arm 701) relative to the body 101, and/or the carriage 703 can include one or more motors for traversing the carriage 703 relative to the scanning arm 701. Accordingly, the collar 702 can rotate 360 degrees around a central support 721 connecting an anchor system 703 to a body 101 of the UAV 100, and the carriage 703 can traverse at least a portion of the scanning arm 701 along a radial path 801 at any given rotational position of the collar 702. Stated differently, the polar gantry system 700 can be configured to traverse the sensor(s) 165 and/or repair tools in a ring shape about a pivot point defined by the rotating collar 702.

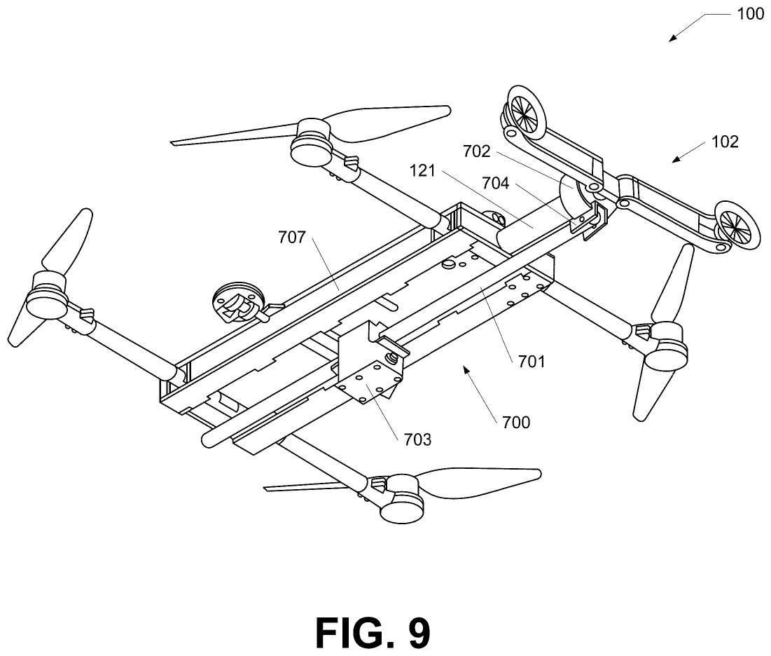

The polar gantry system 700 can be configured to transition between a deployed position (e.g., as shown in FIGS. 7 and 8) and a retracted position (e.g., as shown in FIG. 9). For example, the polar gantry system 700 can include a hinge 704, which can enable the scanning arm 701 to hinge and/or rotate with respect to the collar 702 (e.g., hinge or bend toward or away from the collar 702). Alternatively or in addition, the polar gantry system 700 can include a hinging actuation device, which can be or include an actuator, a cable and pulley system, a motor (e.g., of a mechanized hinging device), or any other system or device configured to open and close the hinge 704.

To transition the polar gantry system 700 to the retracted position, the collar 702 can be rotated to a rotational position in which the hinge 704 is located on the underside of the base 121 of the anchor system 102 (and/or the underside of the body 101), and the hinge 704 can be closed (e.g., via the hinging actuation device) to thereby cause the scanning arm 701 to move into close proximity of the underside of the body 101. For example, while in the retracted position, the scanning arm 701 (e.g., a central longitudinal axis thereof) can be approximately parallel to the central longitudinal axis 101_{AXIS} of the body 101.

Alternatively or in addition, the angle between the central longitudinal axis of the scanning arm 701 and the central longitudinal axis 101_{AXIS} of the body 101 can be greater when the polar gantry system 700 is in the deployed position than when the polar gantry system 700 is in the retracted position. For example, when the deployed is in the retracted position, the angle between the central longitudinal axis of the scanning arm 701 and the central longitudinal axis 101_{AXIS} of the body 101 can be can be zero (or approximately zero) and/or less than 45°, less than approximately 30°, less than approximately 15°, or any other angle that sufficiently moves and/or secures the scanning arm 701 in a position that prevents (or avoids) entanglement or collision of the scanning arm 701 with other components of the UAV 100 and/or external objects.

When the polar gantry system 700 is in the deployed position, the angle between the central longitudinal axis of the scanning arm 701 and the central longitudinal axis 101_{AXIS} of the body 101 can be greater than zero. For example, when the hinging mechanism 132 is in the deployed position, the angle between the central longitudinal axis of the scanning arm 701 and the central longitudinal axis 101_{AXIS} of the body 101 can be an acute angle, a right angle (e.g., approximately 90°), or an obtuse angle (e.g., approximately 95°, approximately 100°, approximately 105°, approximately 110°, approximately 115°, approximately 120°, approximately 125°, approximately 130°, approximately 135°, approximately 140°, approximately 145°, approximately 150°, approximately 155°, approximately 160°, approximately 165°, approximately 170°, approximately 175°).

As illustrated, the UAV 100 can omit a hinging mechanism (e.g., hinging mechanism 132). Alternatively or in addition, the UAV 100 can include the hinging mechanism (e.g., to reduce the moment forces experienced by the UAV 100 while anchored). To the extent, the UAV 100 includes both the polar gantry system 700 and the hinging mechanism 132, the UAV 100 can include the stop arm 151 (or any other stopping mechanism), which can be configured to stop hinging of the body 101 relative to the anchor arms 123 at a position that permits the scanning arm 701 to pass between the underside of the body 101 and the surface of the inspection target without contacting or otherwise physically interacting with any other components of the UAV 100.

Alternatively or in addition, the polar gantry system 700 can include a robotic arm (e.g., in lieu of the scanning arm 701), which can be or can include an articulating arm that can be controlled by the controller of the UAV 100 (or a remote computing device). For example, the sensor(s) 165 and/or repair tool(s) can be mounted to the robotic arm, which can articulate and/or maneuver the sensor(s) 165 and/or repair tool(s) to any particular position within reach of the robotic arm.

Alternatively or in addition, the UAV 100 can include one or more stabilizing legs 321. For example, a stabilizing leg 321 can be attached to a non-rotating portion of the collar 702, the base 121 of the anchor system 102, the anchor arm hub 122 of the anchor system, or at any other location that is closer to the attachment arms 123 than the rotating portion of the collar 702.

Alternatively or in addition, the UAV 100 can be configured to operate the rotor assemblies 113 in an anchored or docked mode, in which the rotor assemblies 113 can “hover” by generating lift to at least partially offset the weight-induced moment forces experienced by the UAV 100 while anchored. For example, rotor assemblies 113 can provide enough lift to offset all (or approximately all) of the weight and/or moment forces of the UAV 100, such that the anchor system 102 experiences little or no downward force. The UAV 100 can be so configured regardless of whether the UAV 100 includes a stabilizing leg 321, but this capability can be particularly helpful if the UAV 100 does not include a stabilizing leg 321 (e.g., by decreasing or eliminating the downward or rotational forces experienced by the anchor system 102).

Referring now to FIG. 10, illustrated is an example drone tether 1000, in accordance with the disclosed technology. Additional variations of the various UAV architectures described herein are contemplated and would not necessarily change the overall operating principles of the disclosed technology. For example, the UAV 100—with any of the various components, systems, and/or functionalities described herein—can include or be connected to a tether system 1000, which can be configured to provide power to, and/or operational control of, the UAV 100. Stated differently, instead of being powered by a battery onboard the vehicle and/or controlled by an onboard controller, the UAV 100 can be powered via a battery system located on the ground and/or controlled by a controller system located on the ground. The tether system 1000 can include a ground system 1001, which can include the ground-based battery system and/or the ground-based controller, and a tether 1002, which can include one or more wires for transmitting power from the ground-based battery system to the UAV 100 and/or transmitting data (e.g., sensor data, control instructions) between the ground-based controller and the various components of the UAV 100. Alternatively or in addition, the ground system 1001 can include a user interface, which can permit a user to control operations of the UAV 100 and/or view mission-related information (e.g., captured images or other sensor data). Alternatively or in addition, the ground system 1001 can be in electrical communication with a separate user device (e.g., the handheld controller 1500 discussed more fully herein).

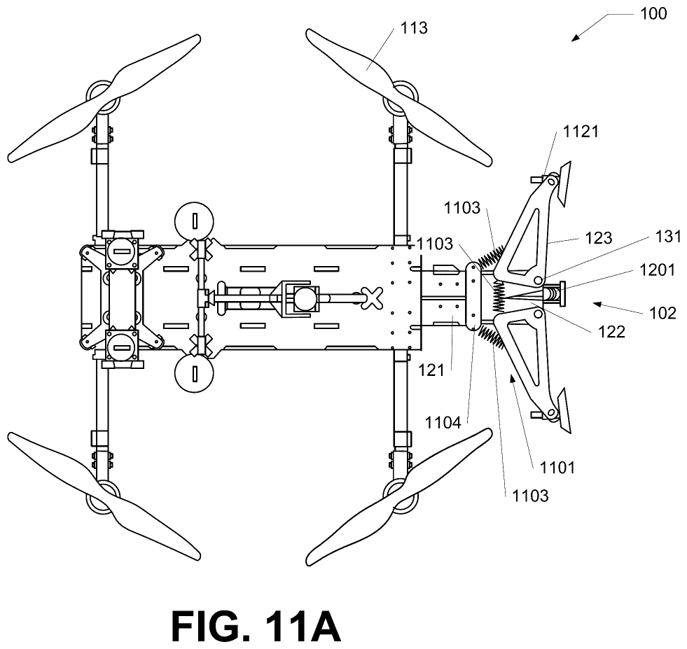

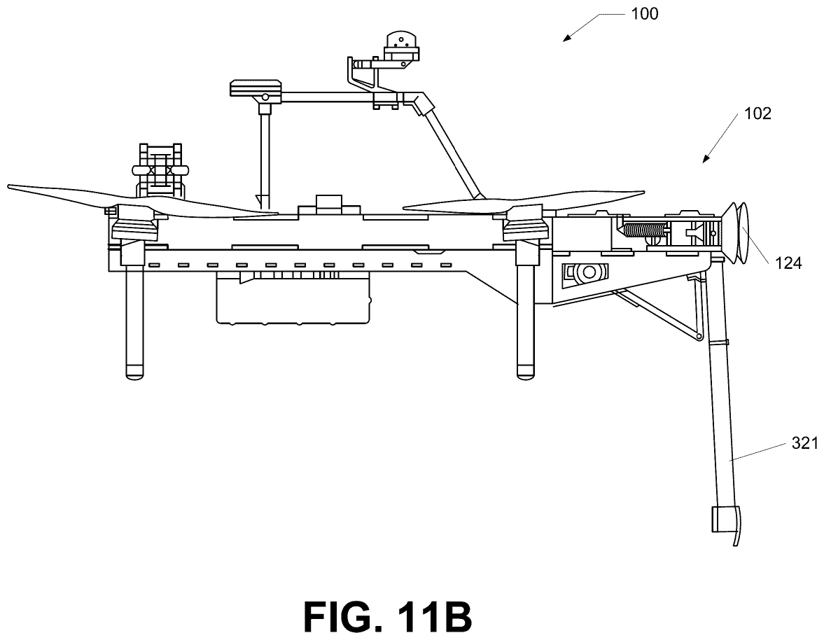

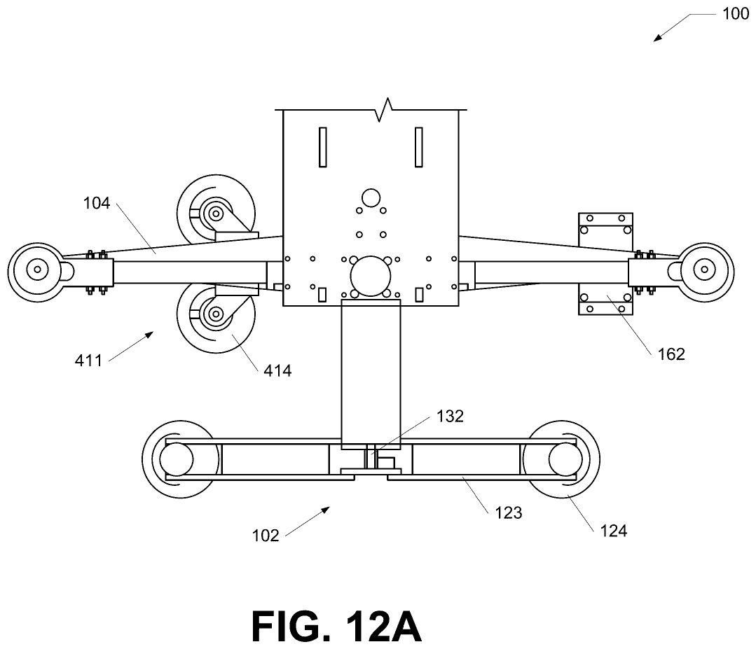

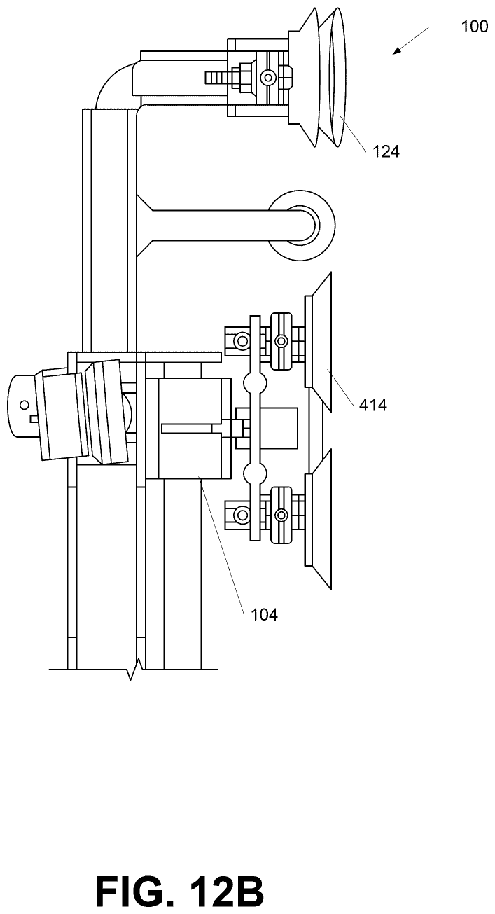

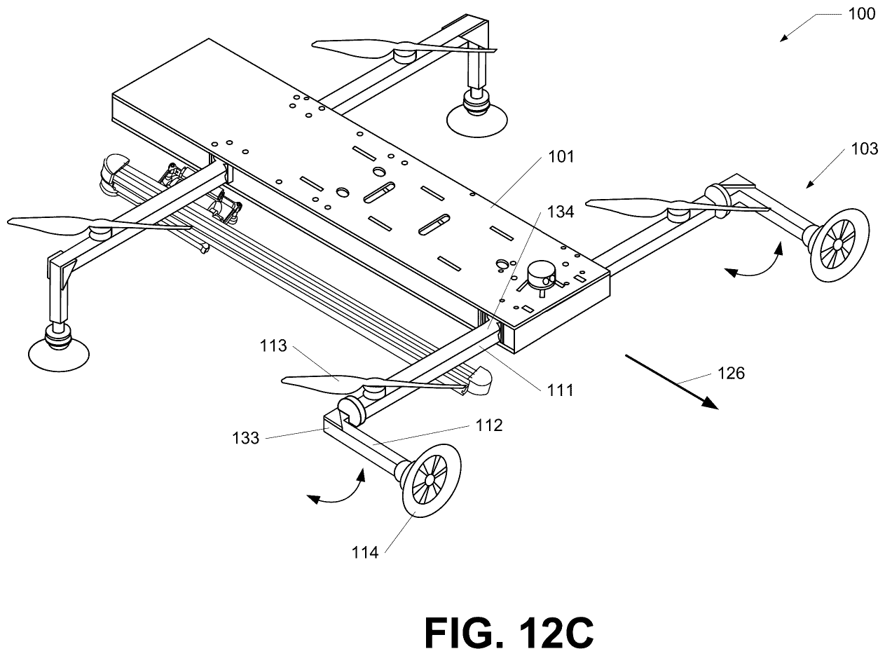

FIGS. 11A, 11B, 12A, and 12B, illustrate various configurations of the anchor system 102, in accordance with the disclosed technology. The examples shown in FIGS. 11A-B and 12A-B can include vacuum suction cups 124, which can be particularly useful for attachment to nonporous surfaces. For example, FIG. 10A illustrates vacuum suction cups 124 that extend outwardly from the front of the body 101 a sufficient distance (e.g., providing sufficient lateral separation from other components of the UAV 100), which can help ensure that the vacuum suction cups 124 are the first components of the UAV 100 to contact the inspection target and/or to help ensure the rotor assemblies 113 do not contact the inspection target during a docking or anchoring event. The UAV 100 shown in FIGS. 11A and 11B can include an anchor system 102 that includes one or more anchor arms 123 having, or incorporated with, a rocker system 1101. The rocker system 1101 can include one or more shock absorbers 1103 to thereby provide a compliant mechanism for adjusting the attitude of the UAV 100 (e.g., relative to the surface of the inspection target) during docking. Each anchor arm 123 can be connected (e.g., pivotally and/or rotatably) connected to the anchor hub 122. The rocker system 1101 can include one or more shock absorbers 1103 (e.g., springs) extending between a given anchor arm 123 and an attachment point on the base 121 of the anchor system 102, such as to a center body 1104 located on, or attached to, the base 121 (or the body 101). Alternatively or in addition, the rocker system 1101 can include one or more shock absorbers 1103 extending between the anchor arms 123. For example, the rocker system 1101 can include one or more shock absorbers 1103 attached to the anchor arms 123 on one or both sides of the corresponding arm hinge 131. The rocker system 1101 can allow rotation of one anchor arm 123 (e.g., rotation induced by contact, such as off-center contact, by the one anchor arm 123 with the inspection target's surface) to be transferred to an adjacent anchor arm 123. Thus, if one vacuum suction cup 124 makes contact with the surface first, one or more other vacuum suction cups 124 can be driven toward (e.g., caused to generally face) the surface to help facilitate contact and attachment of all vacuum suction cups 124. Alternatively or in addition, the rocker system 1101 can help absorb the impulse (e.g., impact forces) of the anchoring and/or docking event.

As discussed previously, a given vacuum suction cup 124 can be mounted on a gimbal 1121 (e.g., a two-axis gimbal), which can help ensure that the entire rim (e.g., perimeter) of the vacuum suction cup 124 makes contact with the surface, which can in turn help ensure a vacuum is created and maintained by the vacuum suction cup 124 and the surface of the inspection target. Vacuum can be drawn using the pump system (e.g., a miniature diaphragm pump with separate pump heads for each vacuum cup), which, as described elsewhere herein, can be configured to ensure each cup (e.g., vacuum suction cup 124) can independently hold a vacuum. One or more micro-electromechanical systems (MEMS) pressure sensors can be connected to each circuit (e.g., one or more tubes fluidly connecting a given vacuum suction cup 124 or group thereof to the pump) to monitor the pressure therein, and the corresponding data can be used (e.g., by the controller or another computing device) to determine whether a given cup is holding vacuum. The UAV 100 can selectively retain or release vacuum pressure within a given vacuum cup 124 (e.g., via a corresponding miniature solenoid valve).

As previously discussed, the UAV 100 can include one or more stabilizing legs 321. As illustrated in FIG. 11B, the stabilizing leg 321 can be or can include a deployable strut, which can include one or more linkages and an actuator or motor. The actuator or motor can drive the one or more linkages, which can extend or retract the stabilizing leg 321, thereby transitioning the stabilizing leg 321 between the retracted position (e.g., a stowed position) and the extended position (e.g., a deployed position in which the stabilizing leg 321 can help carry the cantilever moment of the UAV 100's weight, such as when the rotor assemblies are disengaged while the UAV 100 is anchored). The linkage configuration illustrated in FIG. 11B can enable the stabilizing leg 321 to lock once the fully extended position is reached, thus reducing the torque requirement of the actuator or motor.

Referring now to FIGS. 12A and 12B, vacuum suction cups 124 can be positioned at the distal end of anchor arms 123, which can enable the UAV 100 to dock to the target. As discussed elsewhere herein, the anchor system 102 can include a hinging mechanism 132 configured to hinge or rotate the UAV 100 relative to the inspection target's surface while the UAV 100 is docked or anchored. Once the UAV 100 is docked, the thrust of the rotor assemblies 113 and the UAV 100 can hinge downwardly to cause the underside of the body 101 to face the inspection target's surface. The UAV 100 can include the gantry system 104 mounted to the underside of the body 101. As previously discussed, the gantry system 104 can include one or more sensors 165 and/or one or more repair tools. And as also previously discussed, the gantry system 104 can include the secondary attachment assembly 411, which can include one or more secondary vacuum suction cups 414 that can contact and anchor to the surface, thereby providing a second attachment or anchor point of the UAV 100. The vacuum suction cups 124 and the secondary vacuum suction cups 414 can be alternatingly engaged, positioned (or repositioned) on the surface, and released to cause the UAV 100 to traverse in any direction (forward, backward, up, down, left, right) along the surface of the inspection target. As shown perhaps most clearly in FIG. 12B, the UAV 100 can include one or more wheels 1201 extending from the body 101 or the base 121 of the anchor system 102. The wheel(s) 1201 can be positioned to contact the surface when the UAV 100 is in the unhinged position, to thereby provide support for the UAV 100 and/or to act as a rotational stop, preventing the hinging mechanism 132 from hinging beyond a maximum hinge angle. The wheel(s) 1201 can be passive, or the wheel(s) 1201 be motorized (e.g., include or be mechanically connected to a driving motor), which can help the UAV 100 traverse along the surface of the inspection target.

Alternatively or in addition, the secondary attachment assembly 411 can be attached to the gantry system 104 via a rotational device (e.g., similar to the rotational device described herein with respect to the anchor system 102). Accordingly, the UAV 100 can be configured to “swing” along the surface using the anchor system 102 (including a rotational device) and the secondary attachment assembly 411 (including a rotational device). For example, the UAV 100 can operate by performing the following operations (e.g., sequentially): the anchor system 102 can attach to the surface, the rotational device of the anchor system 102 can rotate the body 101 (e.g., rotate the body approximately 180° or any other angle relative to the anchor system 102), the secondary attachment assembly 411 can attach to the surface, the anchor system 102 can detach from the surface, and the rotating device of the secondary attachment assembly 411 can rotate the body 101 relative to the secondary attachment assembly 411. By repeating some or all of these steps, the UAV 100 can swing across or along the surface (e.g., traverse along the surface in any desired direction(s)).

It is to be understood that, while the anchor system 102 of the UAV 100 has been described herein as being a separate system of the UAV 100, the disclosed technology is not so limited. For example, the anchor system 102 and/or the functionalities provided thereby (e.g., the vacuum suction cups 124 and/or the functionalities provided thereby, the hinging mechanism 132 and/or the functionalities provided thereby) can be included or provided by one or more legs of the UAV 100. For example, referring to FIG. 12C, the UAV 100 can omit the anchor system 102 as illustrated in FIGS. 1A-1C, whether in its entirety or a portion thereof (e.g., the base 121 and all components shown in FIGS. 1A-1C as being attached thereto). Alternatively on in addition, one or more leg structures 103 can be configured to rotate or hinge relative to the body 101 (e.g., about joint 134, about the hinge point 133, a rotatable or hingeable joint located at any position along the leg 112 or the frame 111 or at the intersection therebetween). For example, as illustrated in FIG. 12C, the UAV 100 can include one or more rotational devices 1220, which can each include (or be driven by) one or more motors and can rotate one or more corresponding connection points (e.g., a leg vacuum suction cup 114) relative to the body 101, such as by rotating the leg 112 relative to the body 101. Regardless of the specific rotation or hinge point, one or more front leg structures 103 can be rotatable between a standing position (e.g., the same or similar position as is illustrated in FIG. 1A) and a docking position (e.g., the same or similar position as is illustrated in FIG. 12C, with the leg vacuum suction cups 114 of the front leg structures 103 pointing generally in the engagement direction 126). Thus, the front leg structures 103 can be configured to transition to the docking position while in flight and/or while approaching the surface of an inspection target, and the front leg structures 103 can be configured to transition to the standing position while in flight and approaching a ground surface for landing and/or while docked or anchored to the inspection target.

For example, the UAV 100 can approach the surface of an inspection target, and the front leg structures 103 can transition to the docking position, thereby pointing the corresponding leg vacuum suction cups 114 of the front leg structures 103 to anchor the UAV 100 to the surface, and the UAV 100 can disengage, or decrease the lift provided by, the rotor assemblies 113 and can transition the front leg structures 103 to the standing position, thereby causing the leg vacuum suction cups 114 of the rear leg structures 103 to come into contact with the surface. The leg vacuum suction cups 114 of the rear leg structures 103 can then anchor to the surface, thereby reinforcing or completing the attachment already being provided by the leg vacuum suction cups 114 of the front leg structures 103.

To the extent the UAV 100 includes multiple front leg structures 103, the front leg structures 103 can be rotatable as a single unit, or the front leg structures 103 can be independently rotatable. Further, while the description herein largely refers to rotation of the leg structures 103 in their respective entireties, it is to be understood that the same or similar operation and functionalities can be provided (and is hereby contemplated) by rotating only a portion of a given leg structure, such as rotating the leg 112 relative to the corresponding frame 111 and/or relative to the body 101. Further still, one, some, or all of the leg structures 103 (and/or legs 112) can include any of the various components, devices, systems, or the like described herein with respect to the anchor system 102, such as comprising a flexible material, including one or more arm hinges 131, including a rocker system 1101 and/or one or more shock absorbers 1103, including one or more gimbals, or the like, or any combination thereof.

Alternatively or in addition, the controller (or another computing device) can be configured to control the angle(s) of the front leg structure(s) 103 while approaching the surface of the inspection target (e.g., based on navigation sensor data) to ensure a given leg vacuum suction cup 114 is facing the direction normal to surface at the target landing location for that particular leg vacuum suction cup 114. Stated differently, the controller (or another computing device) can be configured to evaluate the approach angle of the UAV 100 relative to the targeted docking location on the surface and can dynamically adjust the rotational angle of the front leg structure(s) 103 (or the hinge angle of the anchor system 102) to help ensure contact between the entire rim (e.g., perimeter) of a given leg vacuum suction cup 114 with the surface.

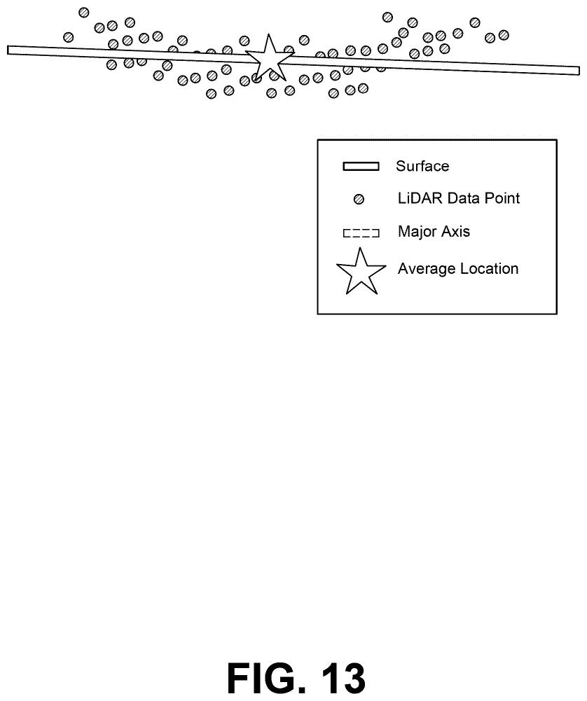

Referring now to FIG. 13, illustrated is an example principle component analysis of LiDAR data obtained by the UAV 100 discussed herein, in accordance with the disclosed technology. The controller (or another computing device) can use various algorithms to analyze LiDAR data (e.g., as defined by a LiDAR point cloud) to determine the distance to (e.g., from the UAV's 100 current location), and orientation of, the surface, as a non-limiting example. Alternatively or in addition, analyses of visual image data (whether algorithmically, by artificial intelligence, by machine learning, or otherwise) can be used to determine the distance to, and orientation of, the surface. With respect to the use of LiDAR data, a simple example implementation is now discussed for the purposes of illustration, and for clarity, certain assumptions are made. To wit, it is assumed that the surface is convex and locally smooth and that the curvature is locally flat. Under these assumptions, the distance to the surface can simply be the distance to the nearest point detected, and the surface normal at this point can be calculated from the orientation of its nearest neighbor(s). However, more advanced algorithms may be desired for inspection targets of more complex shape. Another possible algorithm can involve fitting a shape to the data (e.g., a point, line, circle, or other shape), and inferring the curvature and orientation of the surface based on the fit. A simpler example algorithm, the corresponding data and results of which are illustrated by FIG. 13, can include converting the LiDAR points into the global North-East-Down reference frame and calculating their average position. Then, the orientation of the surface can be found by finding the major axis of the data via the eigenvectors of the covariance matrix. This can be a simple but sufficiently reliable solution, as the covariance matrix is by definition positive semi-definite, and in practice, it can be considered to be always invertible, as the covariances can be considered to never be zero for real data.

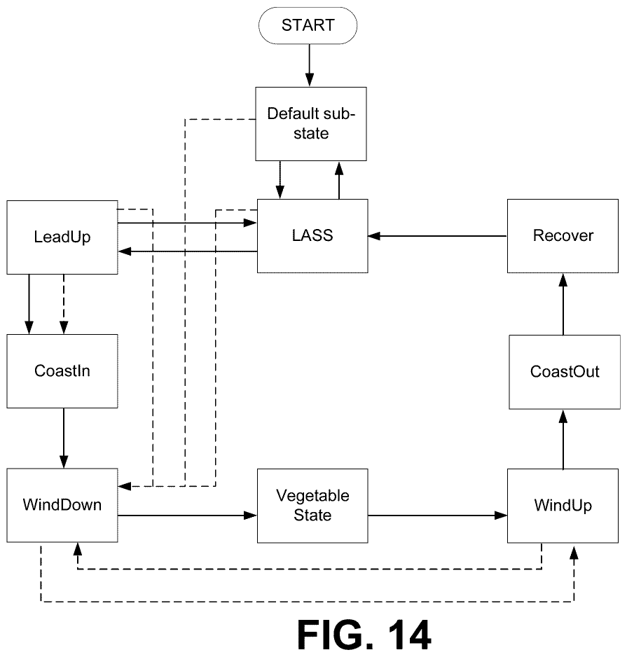

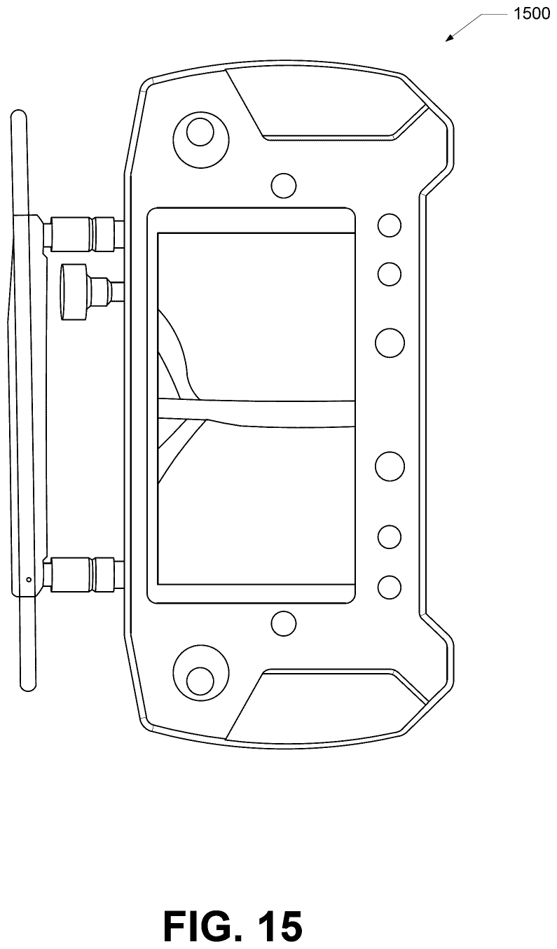

Referring now to FIGS. 14 and 15, illustrated are a state diagram for a docking sequence and a controlling system, respectively. The UAV 100 can include various flight software. The flight software can be executed by a controller located on the UAV 100 (e.g., by a UAV autopilot and/or embedded computer on the UAV). As a non-limiting example, the Ardupilot™ software stack can be used. For example, all computation, including navigation inferences, can take place onboard a CubePilot Cube Orange+™ computing device. However, any suitable autopilot software stack and/or computing hardware can be used.

Control of the UAV 100 during the docking maneuver to the inspection target can be implemented in the form of a finite state machine. For example, the control process can be directed through a series of states, with transitions triggered manually by the pilot, automatically based on sensor feedback, or some combination thereof. A state flow diagram describes the design of a finite state machine. An example state flow diagram of the disclosed technology is shown in FIG. 14 for the purposes of illustration. As shown, the state flow diagram includes several sub-states through which the pilot can command the vehicle. The inspection process can begin in the Default sub-state, which can mimic the Ardupilot Loiter flight mode. When a target is detected, the Loiter Assisted (LASS) mode can be entered. This mode can maintain a desired (e.g., user-adjustable) distance to the inspection target and can map the pilot's inputs to control the velocity parallel and/or perpendicular to the inspection target surface. LeadUp and CoastIn are sub-states that can set the speed and orientation of the UAV 100 for docking. WindDown can occur after the attachment assembly's sensors confirm successful docking. In this state, the UAV 100 can slowly wind down its rotors. The Vegetable state can be a disarmed state of the vehicle in which the rotors are not powered and/or do not turn. The UAV 100 will stay attached to the target surface, and the propellers are stationary. The WindUp sub-state can arm the rotors and increase their rotation rate until the rotors support the UAV's 100 weight. The CoastOut and Recover states can detach the UAV from the inspection target surface and fly the UAV to a safe position. From this state, the UAV 100 can land, or it can enter the LASS sub-state again, or some other maneuver can be performed.

Each of these sub-states can be configured to autonomously or manually transition to other sub-states. The sensors onboard can enable the full docking and undocking sequence to be performed completely autonomously. To further increase autonomy, a handheld controller 1500 (also referred to herein as a remote controller) or any other controller device can enable the pilot to select a point on the inspection surface (e.g., via a touchscreen on the control device illustrated in FIG. 15). Using data from sensors onboard the UAV 100 (such as a combination or fusion of camera data and LiDAR data, as a non-limiting example), the global position of this user-selected point will be known to the UAV's 100 controller, and a fully autonomous precision docking process can be performed by the UAV's 100 controller.

Generally speaking, various designs of finite state machines can be used to control the UAV 100 while interfacing with the inspection target. The above sub-states and transitions should be viewed as examples, but other states and state transitions can be defined for similar purposes.

The handheld controller 1500 can (or can be in communication with a remote computing device that can) automatically classify damaged areas of the inspection target that require further inspection. For example, the handheld controller 1500 can employ existing computer vision algorithms, which are capable of running in real-time. These methods could be extended to use, for instance thermal/infrared imaging or other data sources.

As a non-limiting example, damage detection algorithms can be combined with SLAM and coverage path planning algorithms to yield a fully autonomous solution that can fully scan an inspection target and autonomously decide to dock at areas an operator may have flagged for follow up.

Of course, even more complicated algorithms exist for scenarios where some assumptions need to be removed. When dealing with 3D point clouds or arbitrary surfaces, different techniques can be required. For example, region-growing segmentation can be used to cluster points belonging to the same surface, while RANSAC or Hough plane fitting is useful for extracting dominant planes in noisy data. Principal Component Analysis (PCA) can still be applied in 3D by analyzing the covariance matrix to determine the best-fitting plane. More advanced methods, such as Gaussian Process Regression (GPR) or deep learning-based surface estimation, can infer curvature and local geometry even when the data is sparse or noisy. In highly dynamic environments, Kalman filters or SLAM-based approaches can help refine the position and orientation of the target over time, improving stability and robustness.

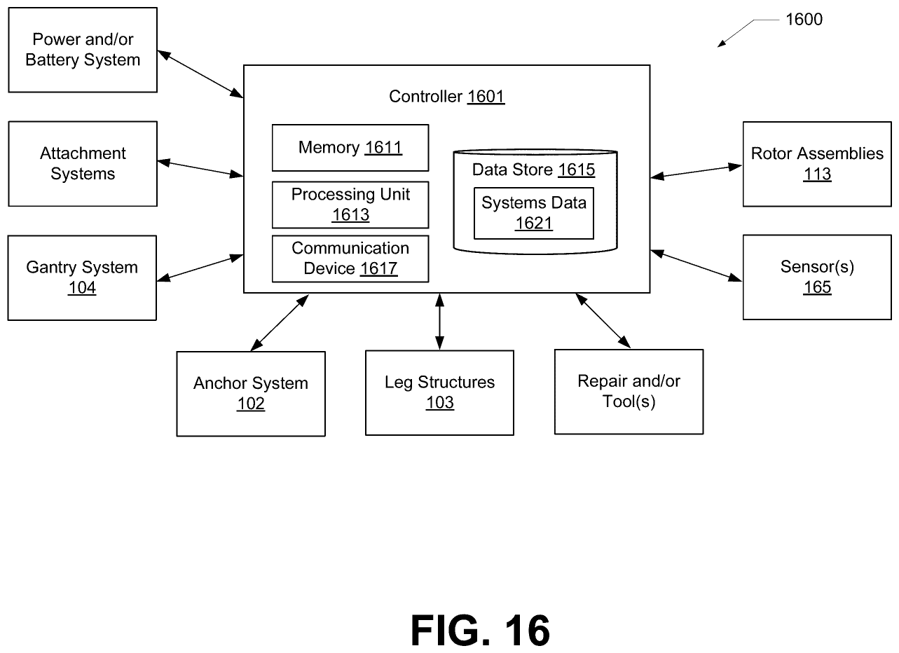

Referring now to FIG. 16, illustrated is a computing infrastructure 1600 of the UAV 100, in accordance with the disclosed technology. The computing infrastructure 1600 can illustrate the primary computing system of the UAV 100. The computing infrastructure 1600 can include a controller 1601 (e.g., a local controller attached to the body 101 or otherwise installed on the UAV 100) in data communication with the various components of the UAV 100, such as the rotor assemblies 113, the sensor(s) 165, one or more repair and inspection tools of the UAV 100, the leg structures 103, the anchor system 102, the gantry system 104, the attachment systems (e.g., electromagnetic attachments, pump systems, etc.), and/or any other system or device powered and/or managed by the controller 1601. The controller 1601 can include a communication device 1617 (e.g., a transceiver, a radio communication device, a cellular communication device), which can enable the UAV 100 to

The controller 1601 can include any particular computing system capable of managing the computational requirements of the UAV 100. For example, the controller 1601 can include memory 1611, one or more processing units 1613, and/or one or more data stores 1615. The controller 1601 can employ the processing unit(s) 1613 can perform any data and/or operational processing requirements of the UAV 100 (e.g., performing or executing one or more inspection operations and/or repair operations, flying and/or navigating the UAV 100, landing the UAV 100, docking and/or undocking the UAV 100). The memory 1611 can include any type of storage device (e.g., temporary fast-transmission and/or short-term data storage used to process data for active system processes. The data store 1615 (or the memory 1611) can function as a long-term data storage which can store the various data necessary for programming the functionalities of the UAV 100 (e.g., performing or executing any of the various actions, steps, methods, processes, operations, or the like discussed herein. For example, the data store 1615 (or the memory 1611) can include systems data 1621, which can include any software, algorithms, processes, models, and/or computational data necessary for the functionalities of the UAV 100 (e.g., flight automation software, inspection software, damage detection algorithms, inspection algorithms, engagement/disengagement flight patterns, autonomous flight software, etc.). The controller 1601 (or any portion thereof) can be located at the UAV 100. Alternatively or in addition, the controller 1601 (or any portion thereof) can be located at the handheld controller 1500 or another remote computing device. For example, the controller 1601 (or any portion thereof) can be located at or in the ground system 1001. In yet another non-limiting example, the controller 1601 can be located remotely and can communicate with the UAV 100 through wireless data communications (e.g., the communication device 1617). Alternatively or in addition, the communication device 1617 can communicate over wired and/or wireless data channels and/or with a central computing infrastructure (not pictured) to receive updates, commands, and/or other system communications.

The controller 1601 can interact with various components of the UAV 100 and manage their various functionalities. For example, the controller 1601 can employ various software to drive the rotor assemblies 115 and their associated motors to promote movement (e.g., flying and/or landing) in the UAV 100. Alternatively or in addition, the controller 1601 can interface with any of the sensors associated with the UAV 100 and discussed herein (e.g., sensors 165, NDT sensors, MEMS sensors, pressure sensors, etc.) to gather data and record pertinent information recorded by the disclosed sensors. Alternatively or in addition, the controller can interface with one or more repair and inspection tools to perform repairs and inspect the structure of a particular inspection target. Alternatively or in addition, the controller 1601 can be in communication with a power (e.g., battery) system and can power the various components and/or functionalities of the UAV 100 (e.g., hinging the legs 112 and/or the frame 111, activating the pump system and/or engaging the vacuum suction cups 114). Alternatively or in addition, the controller 1601 can control the anchor system 102 (and/or at least a portion of one or more leg structures 103) to engage and disengage the UAV 100 from a particular inspection target. Alternatively or in addition, the controller 1601 can control the gantry system 104 (e.g., maneuver the sensor(s) 165 to obtain sensor data and/or the repair tool(s) to perform repair operations. Alternatively or in addition e, the controller 1601 can control the attachment systems (e.g., pump system, electromagnetic systems, etc.) used to actively engage and fix the UAV to a particular object (e.g., an inspection target, such as a wind turbine blade).

The foregoing description of the present systems and processes has been presented only for the purposes of illustration and description and is not intended to be exhaustive or to limit the innovations to the precise forms disclosed. Many modifications and variations are possible in light of the above teaching.

The examples of the present systems and processes were chosen and described in order to explain the principles of the claimed innovations and their practical application so as to enable others skilled in the art to utilize the innovations and various examples with various modifications as are suited to the particular use contemplated. Alternative examples of the disclosed technology will become apparent to those skilled in the art to which the claimed innovations pertain without departing from their spirit and scope. Accordingly, the scope of the claimed innovations is defined by the appended claims rather than the foregoing description and the examples described therein.

What is claimed is:

1. An unmanned aerial vehicle (UAV) comprising:
a body;
one or more rotor assemblies attached to the body, the one or more rotor assemblies being configured to generate lift;
an anchor system attached to the body, the anchor system being configured to detachably attach to a surface of an object; and
a gantry system attached to the body.

2. The UAV of claim 1, wherein the gantry system is located at a bottom of the body.

3. The UAV of claim 1, wherein the gantry system comprises:
one or more tracks extending along a first axis;
a gantry arm extending along a second axis that is approximately perpendicular to the first axis, the gantry arm being configured to traverse the one or more tracks in either direction along the first axis; and
a carriage configured to traverse the gantry arm in either direction along the second axis.

4. The UAV of claim 3, further comprising one or more sensors attached to the carriage.

5. The UAV of claim 3, further comprising one or more repair tools attached to the carriage.

6. The UAV of claim 1, wherein the anchor system comprises one or more anchor structures configured to rotate relative to the body to thereby transition the one or more anchor structures between (i) a first position in which one or more anchor points of the one or more anchor structures face in a generally front-facing direction that extends away from a front of the body and (ii) a second position in which the one or more anchor points of the one or more anchor structures face in a generally bottom-facing direction that extends away from a bottom of the body.

7. The UAV of claim 6, wherein each of the one or more anchor points corresponds to one or more suction devices.

8. The UAV of claim 7, wherein:
the anchor system comprises the one or more suction devices; and
the UAV further comprises a pump system in fluid communication with the one or more suction devices to thereby create a vacuum within the one or more suction devices to enable the one or more suction devices to form a seal with the surface.

9. The UAV of claim 8, further comprising one or more micro-electromechanical systems (MEMS) pressure sensors each configured to monitor a pressure within a corresponding one of the one or more suction devices.

10. The UAV of claim 9, further comprising a controller configured to:
output instructions for the pump system to activate;
determine that the one or more suction devices is maintaining a vacuum with the surface based at least in part on pressure data received from the one or more MEMS pressure sensors; and
output instructions for the body to rotate relative to the one or more anchor structures to thereby cause the bottom of the body to generally face the surface of the object.

11. The UAV of claim 6, wherein the one or more anchor structures comprise one or more legs of the UAV.

12. The UAV of claim 6, wherein the one or more anchor structures comprise one or more anchor arms of the anchor system and the anchor system is attached to a front of the UAV.

13. The UAV of claim 12, wherein the anchor system further comprises:
a base having a proximate end attached to the front of the UAV;
an anchor hub, wherein the one or more anchor structures is attached to the anchor hub; and
a hinging mechanism disposed between the base and the anchor hub, the hinging mechanism being configured to transition between an unhinged position and a hinged position, wherein the unhinged position corresponds to the first position of the one or more anchor structures and the hinged position corresponds to the second position of the one or more anchor structures.

14. The UAV of claim 13, further comprising a rotation device disposed between the hinging mechanism and the one or more anchor structures, wherein the rotation device is configured to rotate the body relative to the one or more anchor structures when the one or more anchor structures are attached to the surface.

15. The UAV of claim 6, wherein the anchor system is a primary anchor system and the UAV further comprises a secondary anchor system configured to (i) contact the surface after the primary anchor system detachably attaches to the surface and (ii) detachably attach to the surface.

16. The UAV of claim 15, further comprising one or more legs, wherein the secondary anchor system comprises one or more secondary suction cups attached to one or more legs.

17. The UAV of claim 15, wherein the secondary anchor system is attached to the gantry system.

18. An unmanned aerial vehicle (UAV) comprising:
a body;
one or more rotor assemblies attached to the body, the one or more rotor assemblies being configured to generate lift;
an anchor system attached to a front of the body, the anchor system being configured to detachably attach to a surface; and
a polar gantry system comprising:
an arm;
a rotating collar configured to rotate the arm relative to the body; and
a carriage configured to traverse at least a portion of the arm.

19. An unmanned aerial vehicle (UAV) comprising:
a body;
one or more rotor assemblies attached to the body, the one or more rotor assemblies being configured to generate lift; and
an anchor system attached to the body, the anchor system comprising:
one or more anchor structures each comprising one or more suction devices; and
a hinging mechanism configured to transition the one or more anchor structures between (i) an unhinged position in which one or more anchor points of the one or more anchor structures face a generally front-facing direction that extends away from a front of the body and (ii) a second position in which the one or more anchor points of the one or more anchor structures face in a generally bottom-facing direction that extends away from a bottom of the body, wherein the anchor system is configured to detachably attach to a surface of an object at the one or more anchor points.

20. The UAV of claim 19, further comprising a gantry system attached to the body and located at the bottom of the body.
